(19) United States
(12) Patent Application Publication
(10) Pub. No.: US 2005/0037506 A1
(43) Pub. Date: Feb. 17, 2005

(54) Methods of determining film thicknesses for an aerosol delivery article

(75) Inventors: Ron L. Hale, Woodside, CA (US); Amy T. Lu, Los Altos, CA (US); Daniel J. Myers, Mountain View, CA (US); Joshua D. Rabinowitz, Princeton, NJ (US)

Correspondence Address: Elaine C. Stracker;Alexza MDC, 1001 East Meadow Circle, Palo Alto, CA, 94303, US

(73) Assignee: Alexza Molecular Delivery Corporation, Palo Alto, CA (US)

(21) Appl. No.: 10/912,462

(22) Filed: Aug. 4, 2004

Related U.S. Application Data
(60) Provisional application No. 60/492,609, filed on Aug. 4, 2003.

(51) Int. Cl. G01N 1/18

(52) U.S. Cl. 436/157

(57) ABSTRACT

Methods for determining the film thickness of a compound composition needed to provide a selected purity and yield of a condensation aerosol via vaporization of the compound composition have applications in aerosol delivery technology, in pulmonary drug delivery, and in other therapeutic treatment regimes. The methods for determining such film thickness, for use in a device having a film of drug composition to be aerosolized, include generating purities and yields of a drug composition by vaporizing films of the drug composition from substrates at two or more temperatures in the range of 150° C. to 500° C. and two or more film thickness in the range of 0.05 to 50 microns, determining from these yields and purities if a thickness and temperature exist where the aerosol has at least 90% purity and at least 50% yield, and repeated such measurements until the selected purity and yield requirement are met.

### FIELD OF THE INVENTION

The present invention relates to the field of devices and methods for administration of pharmaceutically-active drugs. More specifically, the invention relates to inhalation devices and methods for determining drug film thickness for use in production of drug-aerosol particles.

### BACKGROUND OF THE INVENTION

Traditionally, inhalation therapy has played a relatively minor role in the administration of therapeutic agents when compared to more traditional drug administration routes of oral delivery and delivery via injection. Due to drawbacks associated with traditional routes of administration, including slow onset, poor patient compliance, inconvenience, and/or discomfort, alternative administration routes have been sought. Pulmonary delivery is one such alternative administration route which can offer several advantages over the more traditional routes. These advantages include rapid onset, the convenience of patient self-administration, the potential for reduced drug side-effects, the ease of delivery by inhalation, the elimination of needles, and the like. Many preclinical and clinical studies with inhaled compounds have demonstrated that efficacy can be achieved both within the lungs and systemically.

However, despite such results, the role of inhalation therapy in the health care field has remained limited mainly to treatment of asthma, in part due to a set of problems unique to the development of inhalable drug formulations and their delivery modalities, especially formulations for, and delivery by, inhalation.

Metered dose inhaler formulations involve a pressurized propellant, which is frequently a danger to the environment, and generally produce aerosol particle sizes undesirably large for systemic delivery by inhalation. Furthermore, the high speed at which the pressurized particles are released from metered dose inhalers makes the deposition of the particles undesirably dependent on the precise timing and rate of patient inhalation. Also, the metered dose inhaler itself tends to be inefficient because a portion of the dose is lost on the wall of the actuator, and due to the high speed of ejection of the aerosol from the nozzle, much of the drug impacts ballastically on the tongue, mouth, and throat and never gets to the lung.

While solving some of the problems with metered dose inhalers, dry powder formulations are prone to aggregation and low flowability phenomena which considerably diminish the efficiency of dry powder-based inhalation therapies. Such problems are particularly severe for dry powders having a small enough aerosol particle size as to be optimal for deep lung delivery, as difficulty of particle dispersion increases as particle size decreases. Thus, excipients are needed to produce powders that can be dispersed. This mix of drug and excipient must be maintained in a dry atmosphere lest moisture causes agglomeration of the drug into larger particles. Additionally, it is well known that many dry powders grow as they are delivered to the patient's airways due to the high levels of moisture present in the lung.

Liquid aerosol formations similarly involve non-drug constituents, i.e. the solvent, as well as preservatives to stabilize the drug in the solvent. Thus, all liquid aerosol devices must overcome the problems associated with formulation of the compound into a stable liquid. Liquid formulation must be prepared and stored under aseptic or sterile conditions since they can harbor microorganisms. This necessitates the use of preservatives or unit dose packaging. Additionally, solvents, detergents and other agents are used to stabilize the drug formulation. Moreover, the dispersion of liquids generally involves complex and cumbersome devices and is effective only for solutions with specific physical properties, e.g. viscosity. Such solutions cannot be produced for many drugs due to the solubility properties of the drug.

Recently, a method for generating aerosols via volatilization of the drug has been developed, which addresses many of these above mentioned problems. (See, e.g., Rabinowitz, U.S. Publication No. 2003/0015190). This method eliminates the need for excipients to improve flowability and prevent aggregation, solvents or propellants to disperse the compound, solution stabilizers, compound solubility, etc. and hence, the associated problems with these added materials. Additionally, methods have been developed that allow for consistent particle size generation using volatilization.

Volatilization, however, subjects the drug to potential chemical degradation via thermal, oxidative, and/or other means. The activation energies of these degradation reactions depend on molecular structure, energy transfer mechanisms, transitory configurations of the reacting molecular complexes, and the effects of neighboring molecules. One method to help control degradation during volatilization is the use of the flow of gas across the surface of the compound, to create a situation in which a compound's vapor molecules are swept away from its surface. (See e.g., Wensley, Publication No. U.S. 2003/0062042 A1). Additionally, the use of thin films reduces the amount of thermal degradation by decreasing the temporal duration of close contact between the heated drug molecule and other molecules and/or the surface on which the drug is in contact. The ability to determine the film thickness that provides reproducible generation of an aerosol of at least a selected purity level or greater than that level for a minimum selected aerosol yield for use in aerosol delivery devices, however, has not been previously addressed. This determination is critical for producing a commercial aerosol device for therapeutic applications that uses drug volatilization to generate the aerosol.

Thus, there remains a need in the art for methods to determine film thicknesses required to deliver a desired yield and purity for use in devices capable of producing drug aerosols via vaporization. This invention meets these and other needs.

### SUMMARY OF THE INVENTION

The present invention provides methods for determining the film thickness needed to deliver a selected purity and yield of an aerosol using a volatilization/condensation process to generate the aerosol. The methods of the invention can be performed rapidly and provide efficient, reliable, and accurate methods for determining optimal drug film thickness needed for commercial viability of an aerosol device, and in particular, a device for drug delivery.

In one aspect of the invention, a method is provided for determining a film thickness of a drug composition to be aerosolized from a film on a surface of a heat-conductive substrate and a defined heating temperature of the substrate, such that a selected minimum yield and selected minimum purity of aerosol from the film is attained, for use in forming an aerosol delivery article, comprising the steps of:
(a) generating purity(es) of the drug composition in an aerosol formed by vaporizing the film from a substrate at one or more selected film thicknesses within a thickness range of about 0.05 and 50 microns at a selected temperature in the temperature range of about 150° C. to 550° C.,
(b) determining from said purity(es) if a defined thickness exists where the aerosol has a selected minimum purity,
(c) repeating steps (a) and (b), if necessary, for each of one or more different selected film thicknesses in the thickness range of about 0.05 to 50 microns until a defined thickness exists where the aerosol has the selected minimum purity,
(d) generating yields and purities of the drug composition in an aerosol formed by vaporizing the film of a selected thickness of the drug composition from a substrate at two or more different selected temperatures in the temperature range of about 150° C. to 550° C., or, at the same selected temperature in step (a) and one or more different selected temperatures in the temperature range of about 150° C. to 550° C.,
(e) determining from said yields and purities if a defined temperature exists where the aerosol formed has a selected minimum yield, and
(f) repeating steps (d) and (e), if necessary, for each of one or more different temperatures in the temperature range of about 150° C. to 550° C. until a defined temperature exists where the aerosol has the selected minimum yield.

In one embodiment, the method further comprises determining a temperature window over which the yields obtained are equal to or greater than the selected minimum yield for the selected minimum purity. In this method, the temperature window is preferably determined by plotting for a particular thickness, aerosol yield data versus the temperature data and aerosol purity data versus the temperature data on the same graph to determine temperatures at which at least the selected minimum yield and purity is attained.

In another aspect of the invention, a method is provided for determining a film thickness of a drug composition to be aerosolized from a film on a substrate, for use in forming an aerosol delivery article, comprising:
(a) acquiring yields and purities of the drug composition in an aerosol formed by vaporizing the film from the substrate as a function of film thickness and temperature, at two or more selected temperatures within a temperature range of about 250° C. to 550° C. and two or more selected film thicknesses within a thickness range of about 0.05 and 50 microns,
(b) determining from said yields and purities if a thickness and temperature exist where the aerosol has at least 90% purity and at least 50% yield; and
(c) repeating step (a), if necessary, for each of one or more different selected film thicknesses in the thickness range of about 0.05 to 50 microns, or one or more different selected temperatures in the temperature range of about 150° C. to 550° C., respectively, until the purity and yield in (b) are met.

In one embodiment acquiring the yields and purities as a function of film thickness and temperature involves (i) depositing on a substrate a film of the drug composition having a selected thickness in the thickness range of about 0.05-50 microns, (ii) heating the substrate to a selected temperature in the temperature range of about 150° C.-550° C., to vaporize the film, (iii) collecting the aerosol formed from the vaporized drug composition, (iv) determining the percent yield and percent purity of drug composition in the collected aerosol, and (v) repeating steps (i)-(iv) for one or more different selected temperatures in the temperature range of about 150° C. to 550° C. and one or more different selected film thicknesses in the thickness range of about 0.05 and 50 microns.

As noted above, these methods provide rapid means for determining film thicknesses for use in forming aerosol delivery articles for reproducibly generating aerosols having at least the selected purity and yield or greater. These methods are broadly applicable to any drug that can be vaporized and are especially applicable and useful for drugs to be used in inhalation therapy.

These and other aspects of the invention will be more fully appreciated when the following detailed description of the invention is read in conjunction with the accompanying drawings.

### BRIEF DESCRIPTION OF THE DRAWINGS

FIGS. 1A-1B are cross-sectional views of general embodiments of a drug-supply article in accordance with the invention.

FIG. 2A is a perspective view of a drug-delivery device that incorporates a drug-supply article.

FIG. 2B shows another drug-delivery device that incorporates a drug-supply article, where the device components are shown in unassembled form;

FIGS. 3A-3E are high speed photographs showing the generation of aerosol particles from a drug-supply unit.

FIGS. 4A-4B are plots of substrate temperature increase, measured in still air with a thin thermocouple (Omega, Model CO2-K), as a function of time. The substrate in FIG. 4A was heated resistively by connection to a capacitor charged to 13.5 Volts (lower line), 15 Volts (middle line), and 16 Volts (upper line); the substrate in FIG. 4B was heated resistively by discharge of a capacitor at 16 Volts.

FIGS. 5A-5B are plots of substrate temperature, in ° C., as a function of time, in seconds, for a hollow stainless steel cylindrical substrate heated resistively by connection to a capacitor charged to 21 Volts, where FIG. 5A shows the temperature profile over a 4 second time period and FIG. 5B is a detail showing the temperature profile over the first second of heating.

FIG. 6 is a plot of the aerosol purity and yield data as a function of temperature for a 1.3 micron film thickness of alprazolam.

FIG. 7 is a plot of the aerosol purity and yield data as a function of temperature for a 2.8 micron film thickness of prochlorperazine.

FIG. 8 is a plot of the aerosol purity and yield data as a function of temperature for a 10.4 micron film thickness of prochlorperazine.

FIG. 9 is a plot of the aerosol purity and yield data as a function of temperature for a 1.3 micron film thickness of eletriptan.

FIG. 10 is a plot of the aerosol purity and yield data as a function of temperature for a 6.1 micron film thickness of eletriptan.

FIG. 11 is a plot of the aerosol purity and yield data as a function of temperature for a 4.0 micron film thickness of tadalafil.

FIGS. 12A-12B are plots of 100% minus percent purity and 100% minus percent yield as a function of the temperatures and film thicknesses for tadalafil.

FIG. 12C is a plot showing the thickness and temperature window obtained for tadalafil where the aerosol has greater than 95% purity and a yield of greater than 90%.

FIGS. 13A-13B are plots of 100% minus percent purity and 100% minus percent yield as a function of the temperatures and film thicknesses for valdecoxib.

FIG. 13C is a plot showing the thickness and temperature window obtained for valdecoxib where the aerosol has greater than 90% purity and a yield of greater than 50%.

FIGS. 14A-14B are plots of 100% minus percent purity and 100% minus percent yield as a function of the temperatures and film thicknesses for flunisolide.

FIG. 14C is a plot showing the thickness and temperature window obtained for flunisolide where the aerosol has greater than 90% purity and a yield of greater than 85%.

FIGS. 15A-15B are plots of 100% minus percent purity and 100% minus percent yield as a function of the temperatures and film thicknesses for eletriptan.

FIG. 15C is a plot showing the thickness and temperature window obtained for eletriptan where the aerosol has greater than 95% purity and a yield of greater than 75%.

FIGS. 16A-16B are plots of 100% minus percent purity and 100% minus percent yield as a function of the temperatures and film thicknesses for albuterol.

FIG. 16C is a plot showing the thickness and temperature window obtained for albuterol where the aerosol has greater than 95% purity and a yield of greater than 85%.

FIGS. 17A-17B are plots of 100% minus percent purity and 100% minus percent yield as a function of the temperatures and film thicknesses for prochlorperazine.

FIG. 17C is a plot showing the thickness and temperature window obtained for prochlorperazine where the aerosol has greater than 98% purity and a yield of greater than 85%.

FIGS. 18A-18B are plots of 100% minus percent purity and 100% minus percent yield as a function of the temperatures and film thicknesses for sildenafil.

FIG. 18C is a plot showing the thickness and temperature window obtained for sildenafil where the aerosol has greater than 98% purity and a yield of greater than 90%.

FIGS. 19A-19B are plots of 100% minus percent purity and 100% minus percent yield as a function of the temperatures and film thicknesses for fentanyl.

FIG. 19C is a plot showing the thickness and temperature window obtained for fentanyl where the aerosol has greater than 95% purity and a yield of greater than 75%.

### DETAILED DESCRIPTION OF THE INVENTION

The present invention provides methods for determining film thickness of a drug composition to be aerosolized from a film on a surface of a heat-conductive substrate to deliver a selected purity and yield of the resultant aerosol following volatilization of the film and condensation of the vapor thus generated, to produce aerosol particles. Film thickness has been determined to have a substantially greater effect than most other variables on the aerosol purity generated from a vaporization/condensation process involving vaporization of a compound film or coating, (assuming minimal airflow to move the vaporized drug), and thus, is a critical parameter to be controlled, as purity of an aerosol is especially important when an aerosol is being delivered as a therapeutic. Likewise, the yield of the aerosol generated is important in being able to deliver a therapeutic dose to a patient in a cost effective manner in commercial embodiments of an aerosol delivery device. Therefore, methods to determine the film thickness needed when generating aerosols from films or coating to attain a selected minimum purity level and deliver high yields of aerosols help meet the need for quantitative delivery of high purity aerosols for use as therapeutics.

To facilitate understanding of the invention, the disclosure of the invention is organized in sections as follows. First a definition section is provided to define terms and phrases used commonly throughout the disclosure. The next section describes features of the minimum components of the aerosol delivery article along with methods for determining purity and substrate surface area, for which the methods of determining film thickness will be applied. The subsequent section describes the methods of the invention for determining film thickness. The methods for measuring film thickness are divided into two major categories, purity determination followed by yield optimization, and contemporaneous determination of purity and yield. Then various applications of the invention are described; this description is followed by detailed examples illustrating the invention.

I. Definitions

The term “aerosol delivery article” as used herein refers to any component or constituent of an aerosol device, including but not limited the complete device, consisting of at least a heat-conductive substrate and a drug composition film on at least a portion of the surface of the heat-conductive substrate.

The term “condensation aerosol” as used herein refers to an aerosol generated by volatilization of at least some amount of drug from a drug composition to form a vapor of the drug and/or drug composition, and subsequent condensation of this vapor to form aerosol particles.

The term “drug” as used herein means any substance that is used in the prevention, diagnosis, alleviation, treatment or cure of a condition. The drug is preferably in a form suitable for thermal vapor delivery, such as an ester, free acid, or free base form. The drugs are preferably other than recreational drugs. More specifically, the drugs are preferably other than recreational drugs used for non-medicinal recreational purposes, e.g., habitual use to solely alter one's mood, affect, state of consciousness, or to affect a body function unnecessarily, for recreational purposes. The terms “drug”, “compound”, and “medication” are herein used interchangeably.

The drugs of use in the invention typically have a molecular weight in the range of about 150-700, preferably in the range of about 200-650, more preferably in the range of 250-600, still more preferably in the range of about 250-500, and most preferably in the range of about 300-450.

Specific drugs that can be used include, for example but not limitation, drugs of one of the following classes: anesthetics, anticonvulsants, antidepressants, antidiabetic agents, antidotes, antiemetics, antihistamines, anti-infective agents, antineoplastics, antiparkinsonian drugs, antirheumatic agents, antipsychotics, anxiolytics, appetite stimulants and suppressants, blood modifiers, cardiovascular agents, central nervous system stimulants, drugs for Alzheimer's disease management, drugs for cystic fibrosis management, diagnostics, dietary supplements, drugs for erectile dysfunction, gastrointestinal agents, hormones, drugs for the treatment of alcoholism, drugs for the treatment of addiction, immunosuppressives, mast cell stabilizers, migraine preparations, motion sickness products, drugs for multiple sclerosis management, muscle relaxants, nonsteroidal anti-inflammatories, opioids, other analgesics and stimulants, opthalmic preparations, osteoporosis preparations, prostaglandins, respiratory agents, sedatives and hypnotics, skin and mucous membrane agents, smoking cessation aids, Tourette's syndrome agents, urinary tract agents, and vertigo agents.

Typically, where the drug is an anesthetic, it is selected from one of the following compounds: ketamine and lidocaine.

Typically, where the drug is an anticonvulsant, it is selected from one of the following classes: GABA analogs, tiagabine, vigabatrin; barbiturates such as pentobarbital; benzodiazepines such as clonazepam; hydantoins such as phenytoin; phenyltriazines such as lamotrigine; miscellaneous anticonvulsants such as carbamazepine, topiramate, valproic acid, and zonisamide.

Typically, where the drug is an antidepressant, it is selected from one of the following compounds: amitriptyline, amoxapine, benmoxine, butriptyline, clomipramine, desipramine, dosulepin, doxepin, imipramine, kitanserin, lofepramine, medifoxamine, mianserin, maprotoline, mirtazapine, nortriptyline, protriptyline, trimipramine, venlafaxine, viloxazine, citalopram, cotinine, duloxetine, fluoxetine, fluvoxamine, milnacipran, nisoxetine, paroxetine, reboxetine, sertraline, tianeptine, acetaphenazine, binedaline, brofaromine, cericlamine, clovoxamine, iproniazid, isocarboxazid, moclobemide, phenyhydrazine, phenelzine, selegiline, sibutramine, tranylcypromine, ademetionine, adrafinil, amesergide, amisulpride, amperozide, benactyzine, bupropion, caroxazone, gepirone, idazoxan, metralindole, milnacipran, minaprine, nefazodone, nomifensine, ritanserin, roxindole, S-adenosylmethionine, tofenacin, trazodone, tryptophan, and zalospirone.

Typically, where the drug is an antidiabetic agent, it is selected from one of the following compounds: pioglitazone, rosiglitazone, and troglitazone.

Typically, where the drug is an antidote, it is selected from one of the following compounds: edrophonium chloride, flumazenil, deferoxamine, nalmefene, naloxone, and naltrexone.

Typically, where the drug is an antiemetic, it is selected from one of the following compounds: alizapride, azasetron, benzquinamide, bromopride, buclizine, chlorpromazine, cinnarizine, clebopride, cyclizine, diphenhydramine, diphenidol, dolasetron, droperidol, granisetron, hyoscine, lorazepam, dronabinol, metoclopramide, metopimazine, ondansetron, perphenazine, promethazine, prochlorperazine, scopolamine, triethylperazine, trifluoperazine, triflupromazine, trimethobenzamide, tropisetron, domperidone, and palonosetron.

Typically, where the drug is an antihistamine, it is selected from one of the following compounds: astemizole, azatadine, brompheniramine, carbinoxamine, cetrizine, chlorpheniramine, cinnarizine, clemastine, cyproheptadine, dexmedetomidine, diphenhydramine, doxylamine, fexofenadine, hydroxyzine, loratidine, promethazine, pyrilamine and terfenidine.

Typically, where the drug is an anti-infective agent, it is selected from one of the following classes: antivirals such as efavirenz; AIDS adjunct agents such as dapsone; aminoglycosides such as tobramycin; antifungals such as fluconazole; antimalarial agents such as quinine; antituberculosis agents such as ethambutol; β-lactams such as cefmetazole, cefazolin, cephalexin, cefoperazone, cefoxitin, cephacetrile, cephaloglycin, cephaloridine; cephalosporins, such as cephalosporin C, cephalothin; cephamycins such as cephamycin A, cephamycin B, and cephamycin C, cephapirin, cephradine; leprostatics such as clofazimine; penicillins such as ampicillin, amoxicillin, hetacillin, carfecillin, carindacillin, carbenicillin, amylpenicillin, azidocillin, benzylpenicillin, clometocillin, cloxacillin, cyclacillin, methicillin, nafcillin, 2-pentenylpenicillin, penicillin N, penicillin O, penicillin S, penicillin V, dicloxacillin; diphenicillin; heptylpenicillin; and metampicillin; quinolones such as ciprofloxacin, clinafloxacin, difloxacin, grepafloxacin, norfloxacin, ofloxacine, temafloxacin; tetracyclines such as doxycycline and oxytetracycline; miscellaneous anti-infectives such as linezolide, trimethoprim and sulfamethoxazole.

Typically, where the drug is an anti-neoplastic agent, it is selected from one of the following compounds: droloxifene, tamoxifen, and toremifene.

Typically, where the drug is an antiparkinsonian drug, it is selected from one of the following compounds: amantadine, baclofen, biperiden, benztropine, orphenadrine, procyclidine, trihexyphenidyl, levodopa, carbidopa, andropinirole, apomorphine, benserazide, bromocriptine, budipine, cabergoline, eliprodil, eptastigmine, ergoline, galanthamine, lazabemide, lisuride, mazindol, memantine, mofegiline, pergolide, piribedil, pramipexole, propentofylline, rasagiline, remacemide, ropinerole, selegiline, spheramine, terguride, entacapone, and tolcapone.

Typically, where the drug is an antirheumatic agent, it is selected from one of the following compounds: diclofenac, hydroxychloroquine and methotrexate.

Typically, where the drug is an antipsychotic, it is selected from one of the following compounds: acetophenazine, alizapride, amisulpride, amoxapine, amperozide, aripiprazole, benperidol, benzquinamide, bromperidol, buramate, butaclamol, butaperazine, carphenazine, carpipramine, chlorpromazine, chlorprothixene, clocapramine, clomacran, clopenthixol, clospirazine, clothiapine, clozapine, cyamemazine, droperidol, flupenthixol, fluphenazine, fluspirilene, haloperidol, loxapine, melperone, mesoridazine, metofenazate, molindrone, olanzapine, penfluridol, pericyazine, perphenazine, pimozide, pipamerone, piperacetazine, pipotiazine, prochlorperazine, promazine, quetiapine, remoxipride, risperidone, sertindole, spiperone, sulpiride, thioridazine, thiothixene, trifluperidol, triflupromazine, trifluoperazine, ziprasidone, zotepine, and zuclopenthixol.

Typically, where the drug is an anxiolytic, it is selected from one of the following compounds: alprazolam, bromazepam, oxazepam, buspirone, hydroxyzine, mecloqualone, medetomidine, metomidate, adinazolam, chlordiazepoxide, clobenzepam, flurazepam, lorazepam, loprazolam, midazolam, alpidem, alseroxlon, amphenidone, azacyclonol, bromisovalum, captodiamine, capuride, carbcloral, carbromal, chloral betaine, enciprazine, flesinoxan, ipsapiraone, lesopitron, loxapine, methaqualone, methprylon, propanolol, tandospirone, trazadone, zopiclone, and zolpidem.

Typically, where the drug is an appetite stimulant, it is dronabinol.

Typically, where the drug is an appetite suppressant, it is selected from one of the following compounds: fenfluramine, phentermine and sibutramine.

Typically, where the drug is a blood modifier, it is selected from one of the following compounds: cilostazol and dipyridamol.

Typically, where the drug is a cardiovascular agent, it is selected from one of the following compounds: benazepril, captopril, enalapril, quinapril, ramipril, doxazosin, prazosin, clonidine, labetolol, candesartan, irbesartan, losartan, telmisartan, valsartan, disopyramide, flecanide, mexiletine, procainamide, propafenone, quinidine, tocainide, amiodarone, dofetilide, ibutilide, adenosine, gemfibrozil, lovastatin, acebutalol, atenolol, bisoprolol, esmolol, metoprolol, nadolol, pindolol, propranolol, sotalol, diltiazem, nifedipine, verapamil, spironolactone, bumetanide, ethacrynic acid, furosemide, torsemide, amiloride, triamterene, and metolazone.

Typically, where the drug is a central nervous system stimulant, it is selected from one of the following compounds: amphetamine, brucine, caffeine, dexfenfluramine, dextroamphetamine, ephedrine, fenfluramine, mazindol, methyphenidate, pemoline, phentermine, sibutramine, and modafinil.

Typically, where the drug is a drug for Alzheimer's disease management, it is selected from one of the following compounds: donepezil, galanthamine and tacrin.

Typically, where the drug is a drug for cystic fibrosis management, it is selected from one of the following compounds: tobramycin and cefadroxil.

Typically, where the drug is a diagnostic agent, it is selected from one of the following compounds: adenosine and aminohippuric acid.

Typically, where the drug is a dietary supplement, it is selected from one of the following compounds: melatonin and vitamin-E.

Typically, where the drug is a drug for erectile dysfunction, it is selected from one of the following compounds: tadalafil, sildenafil, vardenafil, apomorphine, apomorphine diacetate, phentolamine, and yohimbine.

Typically, where the drug is a gastrointestinal agent, it is selected from one of the following compounds: loperamide, atropine, hyoscyamine, famotidine, lansoprazole, omeprazole, and rebeprazole.

Typically, where the drug is a hormone, it is selected from one of the following compounds: testosterone, estradiol, and cortisone.

Typically, where the drug is a drug for the treatment of alcoholism, it is selected from one of the following compounds: naloxone, naltrexone, and disulfiram.

Typically, where the drug is a drug for the treatment of addiction it is buprenorphine.

Typically, where the drug is an immunosupressive, it is selected from one of the following compounds: mycophenolic acid, cyclosporin, azathioprine, tacrolimus, and rapamycin.

Typically, where the drug is a mast cell stabilizer, it is selected from one of the following compounds: cromolyn, pemirolast, and nedocromil.

Typically, where the drug is a drug for migraine headache, it is selected from one of the following compounds: almotriptan, alperopride, codeine, dihydroergotamine, ergotamine, eletriptan, frovatriptan, isometheptene, lidocaine, lisuride, metoclopramide, naratriptan, oxycodone, propoxyphene, rizatriptan, sumatriptan, tolfenamic acid, zolmitriptan, amitriptyline, atenolol, clonidine, cyproheptadine, diltiazem, doxepin, fluoxetine, lisinopril, methysergide, metoprolol, nadolol, nortriptyline, paroxetine, pizotifen, pizotyline, propanolol, protriptyline, sertraline, timolol, and verapamil.

Typically, where the drug is a motion sickness product, it is selected from one of the following compounds: diphenhydramine, promethazine, and scopolamine.

Typically, where the drug is a drug for multiple sclerosis management, it is selected from one of the following compounds: bencyclane, methylprednisolone, mitoxantrone, and prednisolone.

Typically, where the drug is a muscle relaxant, it is selected from one of the following compounds: baclofen, chlorzoxazone, cyclobenzaprine, methocarbamol, orphenadrine, quinine, and tizanidine.

Typically, where the drug is a nonsteroidal anti-inflammatory, it is selected from one of the following compounds: aceclofenac, acetaminophen, alminoprofen, amfenac, aminopropylon, amixetrine, aspirin, benoxaprofen, bromfenac, bufexamac, carprofen, celecoxib, choline, salicylate, cinchophen, cinmetacin, clopriac, clometacin, diclofenac, diflunisal, etodolac, fenoprofen, flurbiprofen, ibuprofen, indomethacin, indoprofen, ketoprofen, ketorolac, mazipredone, meclofenamate, nabumetone, naproxen, parecoxib, piroxicam, pirprofen, rofecoxib, sulindac, tolfenamate, tolmetin, and valdecoxib.

Typically, where the drug is an opioid, it is selected from one of the following compounds: alfentanil, allylprodine, alphaprodine, anileridine, benzylmorphine, bezitramide, buprenorphine, butorphanol, carbiphene, cipramadol, clonitazene, codeine, dextromoramide, dextropropoxyphene, diamorphine, dihydrocodeine, diphenoxylate, dipipanone, fentanyl, hydromorphone, L-alpha acetyl methadol, lofentanil, levorphanol, meperidine, methadone, meptazinol, metopon, morphine, nalbuphine, nalorphine, oxycodone, papaveretum, pethidine, pentazocine, phenazocine, remifentanil, sufentanil, and tramadol.

Typically, where the drug is an other analgesic it is selected from one of the following compounds: apazone, benzpiperylon, benzydramine, caffeine, clonixin, ethoheptazine, flupirtine, nefopam, orphenadrine, propacetamol, and propoxyphene.

Typically, where the drug is an opthalmic preparation, it is selected from one of the following compounds: ketotifen and betaxolol.

Typically, where the drug is an osteoporosis preparation, it is selected from one of the following compounds: alendronate, estradiol, estropitate, risedronate and raloxifene.

Typically, where the drug is a prostaglandin, it is selected from one of the following compounds: epoprostanol, dinoprostone, misoprostol, and alprostadil.

Typically, where the drug is a respiratory agent, it is selected from one of the following compounds: albuterol, ephedrine, epinephrine, fomoterol, metaproterenol, terbutaline, budesonide, ciclesonide, dexamethasone, flunisolide, fluticasone propionate, triamcinolone acetonide, ipratropium bromide, pseudoephedrine, theophylline, montelukast, and zafirlukast.

Typically, where the drug is a sedative and hypnotic, it is selected from one of the following compounds: butalbital, chlordiazepoxide, diazepam, estazolam, flunitrazepam, flurazepam, lorazepam, midazolam, temazepam, triazolam, zaleplon, zolpidem, and zopiclone.

Typically, where the drug is a skin and mucous membrane agent, it is selected from one of the following compounds: isotretinoin, bergapten and methoxsalen.

Typically, where the drug is a smoking cessation aid, it is selected from one of the following compounds: nicotine and varenicline.

Typically, where the drug is a Tourette's syndrome agent, it is pimozide.

Typically, where the drug is a urinary tract agent, it is selected from one of the following compounds: tolteridine, darifenicin, propantheline bromide, and oxybutynin.

Typically, where the drug is a vertigo agent, it is selected from one of the following compounds: betahistine and meclizine.

The term “drug composition” as used herein refers to a composition that comprises only pure drug, two or more drugs in combination, or one or more drugs in combination with additional components. Additional components can include, for example, pharmaceutically acceptable excipients, carriers, and surfactants.

The term “drug degradation product” as used herein refers to a compound resulting from a chemical modification of the drug compound during the drug vaporization-condensation process. The modification, for example, can be the result of a thermally or photochemically induced reaction. Such reactions include, without limitation, oxidation and hydrolysis.

The term “effective human therapeutic dose” means the amount required to achieve the desired effect or efficacy, e.g., abatement of symptoms or cessation of the episode, in a human. The dose of a drug delivered in the thermal vapor refers to a unit dose amount that is generated by heating of the drug under defined delivery conditions.

The term “film” as used herein refers to drug composition that has been deposited on or adhered to at least a portion of a surface. Preferably, the thickness of the film is between about 0.05 to 50 microns. The term film is used interchangeable herein with the term “coating.”

The term “fraction drug degradation product” as used herein refers to the quantity of drug degradation products present in the aerosol particles divided by the quantity of drug plus drug degradation product present in the aerosol, i.e. (sum of quantities of all drug degradation products present in the aerosol)/((quantity of drug composition present in the aerosol)+(sum of quantities of all drug degradation products present in the aerosol)). The term “percent drug degradation product” as used herein refers to the fraction drug degradation product multiplied by 100%, whereas “purity” of the aerosol refers to 100% minus the percent drug degradation products. To determine the percent or fraction drug degradation product, typically, the aerosol is collected in a trap, such as a filter, glass wool, an impinger, a solvent trap, or a cold trap, with collection in a filter particularly preferred. The trap is then typically extracted with a solvent, e.g. acetonitrile, and the extract subjected to analysis by any of a variety of analytical methods known in the art, with gas and liquid chromatography preferred methods, and high performance liquid chromatography particularly preferred. The gas or liquid chromatography method includes a detector system, such as a mass spectrometry detector or ultraviolet absorption detector. Ideally, the detector system allows determination of the quantity of the components of the drug composition and drug degradation product by weight. This is achieved in practice by measuring the signal obtained upon analysis of one or more known mass(es) of components of the drug composition or drug degradation product (standards) and comparing the signal obtained upon analysis of the aerosol to that obtained upon analysis of the standard(s), an approach well known in the art. In many cases, the structure of a drug degradation product may not be known or a standard of the drug degradation product may not be available. In such cases, it is acceptable to calculate the weight fraction of the drug degradation product by assuming that the drug degradation product has an identical response coefficient (e.g. for ultraviolet absorption detection, identical extinction coefficient) to the drug component or components in the drug composition. When conducting such analysis, for practicality drug degradation products present at less than a very small fraction of the drug compound, e.g. less than 0.2% or 0.1% or 0.03% of the drug compound, are generally excluded from analysis. Because of the frequent necessity to assume an identical response coefficient between drug and drug degradation product in calculating a weight percentage of drug degradation products, it is preferred to use an analytical approach in which such an assumption has a high probability of validity. In this respect, high performance liquid chromatography with detection by absorption of ultraviolet light at 225 nm is a preferred approach. UV absorption at other than 225 nm, most commonly 250 nm, was used for detection of compounds in limited cases where the compound absorbed substantially more strongly at 250 nm or for other reasons one skilled in the art would consider detection at 250 nm the most appropriate means of estimating purity by weight using HPLC analysis. In certain cases where analysis of the drug by UV was not viable, other analytical tools such as GC/MS or LC/MS were used to determine purity.

The term “thermal vapor” as used herein refers to a vapor phase, aerosol, or mixture of aerosol-vapor phases, formed preferably by heating. The thermal vapor may comprise a drug and optionally a carrier, and may be formed by heating the drug and optionally a carrier. The term “vapor phase” refers to a gaseous phase. The term “aerosol phase” refers to solid and/or liquid particles suspended in a gaseous phase.

II. Aerosol Delivery Article

The methods of film thickness determination of the invention are applicable to the forming of an aerosol delivery article. This article has as minimum components, a heat conductive substrate and a drug composition film on at least a portion of the heat conductive substrate. The article is particularly suited for use in a device for inhalation therapy for delivery of a therapeutic agent to the lungs of a patient, for local or systemic treatment. The article is also suited for use in a device that generates an air stream, for application of aerosol particles to a target site. For example, a stream of gas carrying aerosol particles can be applied to treat an acute or chronic skin condition, can be applied during surgery at the incision site, or can be applied to an open wound. As one of skill in the art can readily appreciate, the methods of the invention are applicable not only to an article consisting of the above components but any aerosol delivery article that consists of these and any other additional number of components up to, and including, the complete delivery device itself. Discussed below are aspects of the substrate, the drug composition film, aerosol purity, and surface area features of the substrate for delivery of therapeutic amounts of a drug composition.

A. Substrates

1. Substrate Materials, Surface Characteristics, and Geometry

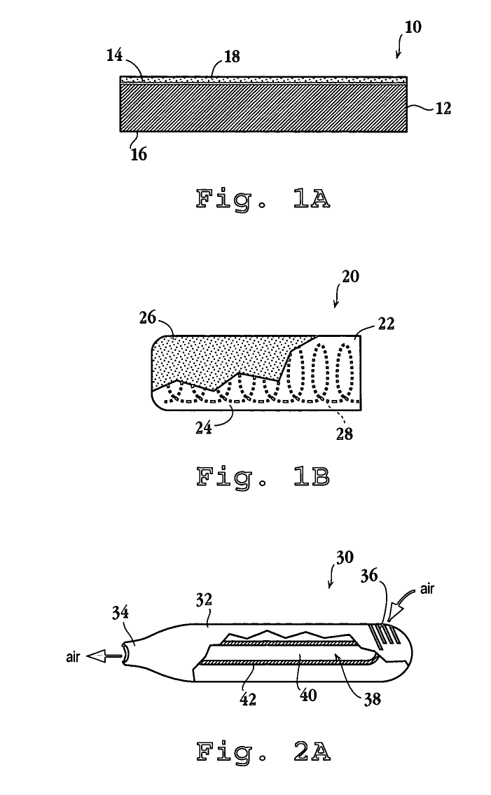

An illustrative example of one type of aerosol delivery article that can be optimized using the methods of the invention is shown in cross-sectional view in FIG. 1A. Aerosol delivery article 10 is comprised of a heat-conductive substrate 12.

Heat-conductive materials for use in forming the substrate are well known, and typically include metals, such as aluminum, iron, copper, stainless steel, and the like, alloys, ceramics, and filled polymers.

The methods of the invention also have applicability to treated substrates which provide improve purity of the drug composition aerosol generated from films applied thereon. Exemplary substrates of this type are described in U.S. provisional patent application for SUBSTRATES FOR DRUG DELIVERY DEVICE AND METHODS OF PREPARING AND USE, filed Aug. 4, 2003, contemporaneously with this instant application and which is incorporated herein by reference.

Metal substrates disclosed therein have a treated exterior surface. The treated exterior surface is typically an acid treated, heat treated, or metal oxide-enriched surface. The treatment approaches disclosed therein are applicable to a diversity of metals and alloys, including without limitation steel, stainless steel, aluminum, chromium, copper, iron, titanium, and the like, with aluminum, copper, and steel, especially stainless steel, being particularly preferred embodiments.

Preferred substrates are those substrates that have surfaces with relatively few or substantially no surface irregularities so that a molecule of a compound vaporized from a film of the compound on the surface is unlikely to acquire sufficient energy through contact with either other hot vapor molecules, hot gases surrounding the area, or the substrate surface to result in cleavage of chemical bonds and hence compound decomposition. To avoid such decomposition, the vaporized compound should transition rapidly from the heated surface or surrounding heated gas to a cooler environment. While a vaporized compound from a surface may transition through Brownian motion or diffusion, the temporal duration of this transition may be impacted by the extent of the region of elevated temperature at the surface which is established by the velocity gradient of gases over the surface and the physical shape of surface. A high velocity gradient (a rapid increase in velocity gradient near the surface) results in minimization of the hot gas region above the heated surface and decreases the time of transition of the vaporized compound to a cooler environment. Likewise, a smoother surface facilitates this transition, as the hot gases and compound vapor are not precluded from rapid transition by being trapped in, for example, depressions, pockets or pores. Although a variety of substrates can be used, specifically preferred substrates are those that have impermeable surfaces or have an impermeable surface coating, such as, for example, metal foils, smooth metal surfaces, non-porous ceramics, etc. For the reasons stated above, non-preferred substrates for producing a therapeutic amount of a compound with less than 10% compound degradation via vaporization are those that have a substrate density of less than 0.5 g/cc, such as, for example, yarn, felts and foams, or those that have a surface area of less than 1 mm²/particle such as, for example small alumina particles, and other inorganic particles.

The substrate can be of virtually any geometry, the square or rectangular configuration shown in FIG. 1A is merely exemplary. Heat-conductive substrate 12 has an upper surface 14 and a lower surface 16.

FIG. 1B is a perspective, cut-away view of an alternative geometry of the aerosol delivery article. Article 20 is comprised of a cylindrically-shaped substrate 22 formed from a heat-conductive material. Substrate 22 has an exterior surface 24 that is preferably impermeable by virtue of material selection, surface treatment, or the like. Deposited on the exterior surface of the substrate is a film 26 of the drug composition. As will be described in more detail below, in use the substrate of the aerosol delivery article is heated to vaporize all or a portion of the drug film. Control of air flow across the substrate surface during vaporization produces the desired size of drug-aerosol particles.
2. Heating of the Substrate

Typically, heat is applied to the substrate to vaporize the drug composition film. It will be appreciated that the temperature to which the substrate is heated will vary according to the drug's vaporization properties and the selected minimum purities and yields of the aerosol, but the substrate is typically heated to a temperature of at least about 150° C., preferably of at least about 250 ° C., more preferably at least about 300° C. or 350° C. Heating the substrate produces a thermal vapor that in the presence of the flowing gas generates aerosol particles in the desired size range. Thus, the aerosol delivery article can further comprise a heat source for supplying heat to said substrate to produce a substrate temperature greater than 150° C. and to substantially volatilize the drug composition film from the substrate. Preferably, the temperature is sufficient to substantially volatilize the drug composition film from the substrate in a period of 2 seconds or less, more preferably in less than 1 second, still more preferably in less than 500 milliseconds, and most preferably in less than 200 milliseconds.

In FIG. 1B, the drug composition film and substrate surface is partially cut-away in the figure to expose a heating element 28 disposed in the substrate. The substrate can be hollow with a heating element inserted into the hollow space or solid with a heating element incorporated into the substrate. The heating element in the embodiment shown takes the form of an electrical resistive wire that produces heat when a current flows through the wire. Other heating elements are suitable, including but not limited to a solid chemical fuel, chemical components that undergo an exothermic reaction, inductive heat, etc. Heating of the substrate by conductive heating is also suitable. One exemplary heating source is described in U.S. patent application for SELF-CONTAINED HEATING UNIT AND DRUG-SUPPLY UNIT EMPLOYING SAME, U.S. Ser. No. 60/472,697 filed May 21, 2003 which is incorporated herein by reference.

As one of skill in the art will recognize, depending on the choice of substrate material, the optimal means of heating may vary. For example, if the substrate material is stainless steel, a preferred means of heating is electrical resistive heating. On the other hand, if the substrate material is aluminum, a preferential means to vaporize the drug composition on the substrate surface is by conductive means, i.e., by bringing the aluminum in contact with a heat source (e.g., a halogen bulb), rather than electrical resistance means, due to the higher thermal conductivity and higher electrical conductivity of aluminum relative to stainless steel.

In the instant invention only one substrate material was used in the studies: stainless steel foil. However, as disclosed above, and as one of skill in the art will recognize, a variety of different substrates can be used. Method B below details the procedures for forming a drug film on this substrate and the method of heating the substrate.

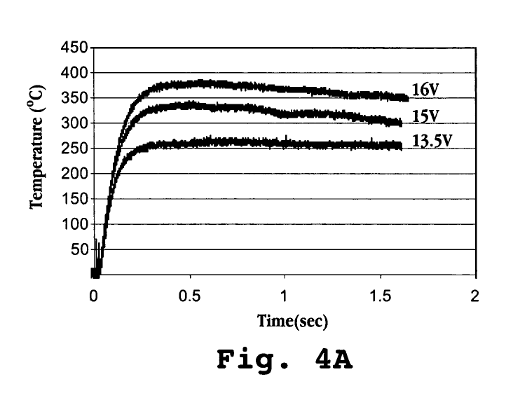

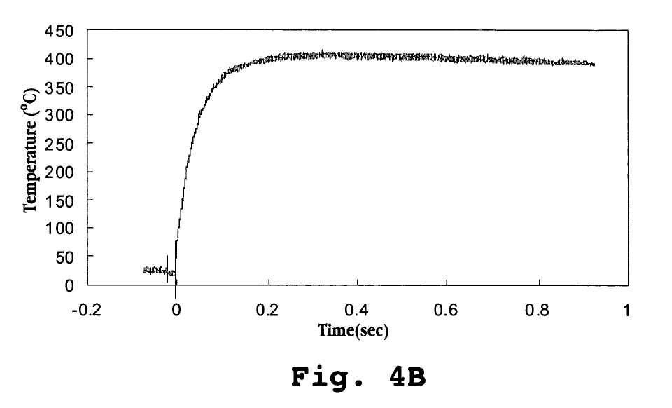

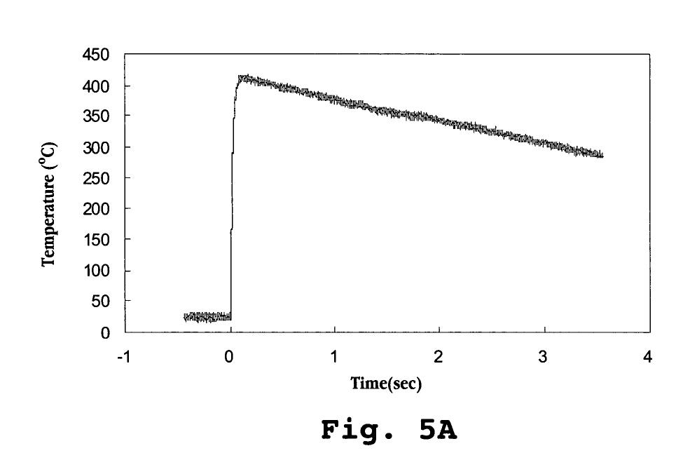

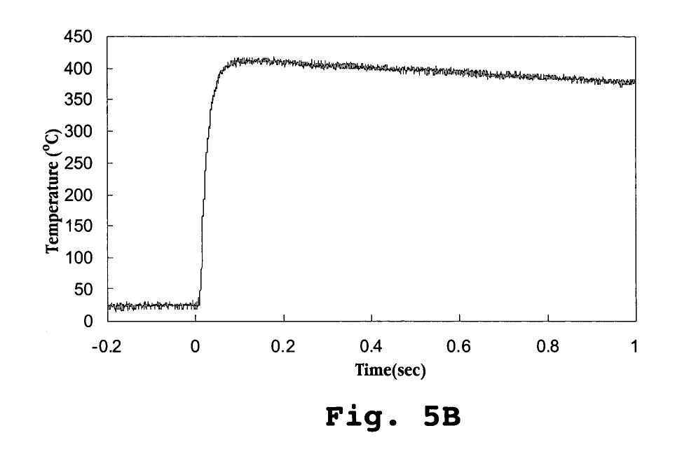

In Method B, volatilization of the drug composition films from stainless steel foil was via resistive heating. This involved placing the substrate between a pair of electrodes connected to a capacitor. The capacitor was charged to between 14-17 Volts to resistively heat the substrate. FIG. 4A is a plot of temperature increase in ° C., measured in no airflow with a thin thermocouple (Omega, Model CO2-K), against time, in seconds, for a stainless steel foil substrate resistively heated by charging the capacitor to 13.5 V (lower line), 15 V (middle line), and 16 V (upper line). When charged with 13.5 V, the substrate temperature increase was about 250 ° C. within about 200-300 milliseconds. As the capacitor voltage increased, the peak temperature of the substrate also increased. Charging the capacitor to 16V heated the foil substrate temperature about 375 ° C. in 200-300 milliseconds (to a maximum temperature of about 400° C.).

FIG. 4B shows the time-temperature relationship for a 0.005 inch thick stainless steel foil substrate that was heated by a 1 Farad capacitor charged 16 V, again measured by a thin thermocouple (Omega Model CO2-K). The substrate reached its peak temperature of 400 ° C. in about 200 milliseconds, and maintained that temperature for the 1 second testing period.

Drug Composition Film

In addition to the substrate, the aerosol delivery article has a drug composition film. As shown in FIG. 1A, deposited on all or a portion of the upper surface 14 of the substrate is a film 18 of the drug composition. The drug composition can consist of two or more drugs. Preferably, however, the drug composition comprises pure drug.
1. Film Thickness

The film thickness for a given drug composition is such that aerosol particles, formed by vaporizing the drug composition by heating the substrate and entraining the vapor in a gas, have (i) a selected minimum purity or greater and (ii) a selected minimum yield or greater, as is determined by the methods of the present invention. Typically, the film has a thickness between 0.05 and 50 microns.

The drug compositions used may be such that, when vaporized from a film on an impermeable surface of a heat conductive substrate, the aerosol generated exhibits an increasing level of drug degradation products with increasing film thicknesses at a set temperature, as was demonstrated by many of the drug compositions used in the Examples. For this general type of drug composition, the optimal film thickness on the substrate for forming an aerosol delivery article, as determined by the present invention, will typically be less than 50 micron, and generally between 0.05 and 20 microns, e.g., the maximum or near-maximum thickness within this range that allows formation of a particle aerosol with a selected minimum drug purity of, e.g., 95% or the equivalent, e.g., drug degradation products of less than 5%. More typically, these film thicknesses tend to range between 0.1-15 μm, still more typically between 0.2-10 μm, and most typically between 1-10 μm.

Alternatively, the drug composition may show less than 5-10% degradation even at film thicknesses greater than 20 microns. For these compounds, a film thickness greater than 20 microns, e.g., 20-50 microns, may be determined as optimal for forming the aerosol delivery article, particularly where a relatively large drug dose is desired.
2. Film Deposition on the Substrate

Film deposition is achieved by a variety of methods, depending in part on the physical properties of the drug and on the desired drug film thickness. Exemplary methods include, but are not limited to, preparing a solution of drug in solvent, applying the solution to the exterior surface and removing the solvent to leave a film of drug. The drug solution can be applied by dipping the substrate into the solution, spraying, brushing, or otherwise applying the solution to the substrate. Alternatively, a melt of the drug can be prepared and applied to the substrate. For drugs that are liquids at room temperature, thickening agents can be admixed with the drug to permit application of a solid drug film. Examples of drug film deposition on a variety of substrates are given below.

The drug composition films used in the Examples were formed by applying a solution containing the drug onto the substrate. As described in Method A, a solution of the drug in a solvent was prepared. A variety of solvents can be used and selection is based, in part, on the solubility properties of the drug and the desired solution concentration. Common solvent choices included methanol, acetone, chloroform, dichloromethane, other volatile organic solvents, dimethylformamide, water, and solvent mixtures. The drug solution was applied to the substrate by dip coating, yet other methods such as spray coating are contemplated as well. Alternatively, a melt of the drug can be applied to the substrate.
3. Determination of Film Thickness Deposited on the Substrate

In Examples discussed below, a substrate containing a drug film of a certain thickness was prepared. To determine the thickness of the drug film deposited on the substrate, one method that can be used is to determine the area of the substrate and calculate drug film thickness using the following relationship:
film thickness (cm)=drug mass (g)/[drug density (g/cm³)×substrate area (cm²)]

The drug mass can be determined by weighing the substrate before and after formation of the drug film or by extracting the drug and measuring the amount analytically. Drug density can be experimentally determined by a variety of techniques, known by those of skill in the art or found in the literature or in reference texts, such as in the CRC. An assumption of unit density is acceptable if an actual drug density is not known. Alternatively, the film thickness can be measured directly by techniques known by those of skill in the art, such as, for example, optical reflectometry, beta backscattering, SEM, etc.

C. Purity

In studies conducted in support of the invention, a variety of drugs were deposited on a heat-conductive, impermeable substrate and the substrate was heated to a temperature sufficient to generate a thermal vapor. Purity of drug-aerosol particles in the thermal vapor was determined. The term “purity” as used herein, with respect to the aerosol purity, means the fraction of drug composition in the aerosol/[the fraction of drug composition in the aerosol plus drug degradation products]. Thus purity is relative with regard to the purity of the starting material. For example, when the starting drug or drug composition used for substrate coating contained detectable impurities, the reported purity of the aerosol does not include those impurities present in the starting material that were also found in the aerosol, e.g., in certain cases if the starting material contained a 1% impurity and the aerosol was found to contain the identical 1% impurity, the aerosol purity may nevertheless be reported as >99% pure, reflecting the fact that the detectable 1% purity was not produced during the vaporization-condensation aerosol generation process.

To determine the percent or fraction drug degradation product, and hence the purity of the aerosol, typically, the aerosol is collected in a trap, such as a filter, glass wool, an impinger, a solvent trap, or a cold trap, with collection in a filter particularly preferred. The trap is then typically extracted with a solvent, e.g. acetonitrile, and the extract subjected to analysis by any of a variety of analytical methods known in the art, with gas and liquid chromatography preferred methods, and high performance liquid chromatography particularly preferred. The gas or liquid chromatography method includes a detector system, such as a mass spectrometry detector or ultraviolet absorption detector. Ideally, the detector system allows determination of the quantity of the components of the drug composition and drug degradation product by weight. This is achieved in practice by measuring the signal obtained upon analysis of one or more known mass(es) of components of the drug composition or drug degradation product (standards) and comparing the signal obtained upon analysis of the aerosol to that obtained upon analysis of the standard(s), an approach well known in the art. In many cases, the structure of a drug degradation product may not be known or a standard of the drug degradation product may not be available. In such cases, it is acceptable to calculate the weight fraction of the drug degradation product by assuming that the drug degradation product has an identical response coefficient (e.g. for ultraviolet absorption detection, identical extinction coefficient) to the drug component or components in the drug composition. When conducting such analysis, for practicality drug degradation products present at less than a very small fraction of the drug compound, e.g. less than 0.2% or 0.1% or 0.03% of the drug compound, are generally excluded from analysis. Because of the frequent necessity to assume an identical response coefficient between drug and drug degradation product in calculating a weight percentage of drug degradation products, it is preferred to use an analytical approach in which such an assumption has a high probability of validity. In this respect, high performance liquid chromatography with detection by absorption of ultraviolet light at 225 nm is a preferred approach. UV absorption at other than 225 nm, most commonly 250 nm, is used for detection of compounds in limited cases where the compound absorbs substantially more strongly at 250 nm or for other reasons one skilled in the art would consider detection at 250 nm the most appropriate means of estimating purity by weight using HPLC. analysis. In certain cases where analysis of the drug by UV is not viable, other analytical tools such as GC/MS or LC/MS may be used to determine purity.

D. Surface Area of the Substrate

Another feature of the aerosol delivery article is that the substrate surface area is typically such that a therapeutic dose of the drug aerosol is delivered in a single use of the device when used by a subject or such that dose titration by the patient to deliver a minimum effective dose is possible. For an aerosol delivery device or assembly of the present invention, the yield from a single dose may be determined by collecting the thermal vapor evolved upon actuation of the device or assembly and analyzing its composition as described herein, and comparing the results of analysis of the thermal vapor to those of a series of reference standards containing known amounts of the drug. The amount of drug or drugs required in the starting composition for delivery as a thermal vapor depends on the amount of drug or drugs entering the thermal vapor phase when heated (i.e., the dose produced by the starting drug or drugs), the bioavailability of the thermal vapor phase drug or drugs, the volume of patient inhalation, and the potency of the thermal vapor drug or drugs as a function of plasma drug concentration.

Typically, the bioavailability of thermal vapors ranges from 20-100% and is preferably in the range of 50-100% relative to the bioavailability of drugs infused intravenously. The potency of the thermal vapor drug or drugs per unit plasma drug concentration is preferably equal to or greater than that of the drug or drugs delivered by other routes of administration. It may substantially exceed that of oral, intramuscular, or other routes of administration in cases where the clinical effect is related to the rate of rise in plasma drug concentration more strongly than the absolute plasma drug concentration. In some instances, thermal vapor delivery results in increased drug concentration in a target organ such as the brain, relative to the plasma drug concentration (Lichtman et al., The Journal of Pharmacology and Experimental Therapeutics 279:69-76 (1996)). Thus, for medications currently given orally, the effective human therapeutic dose of that drug in thermal vapor form is generally less than the standard oral dose. Preferably it will be less than 80%, more preferably less than 40%, and most preferably less than 20% of the standard oral dose. For medications currently given intravenously, the drug dose in a thermal vapor will generally be similar to or less than the standard intravenous dose. Preferably it will be less than 200%, more preferably less than 100%, and most preferably less than 50% of the standard intravenous dose.

Determination of the appropriate dose of thermal vapor to be used to treat a particular condition can be performed via animal experiments and a dose-finding (Phase I/II) clinical trial. Preferred animal experiments involve measuring plasma drug concentrations after exposure of the test animal to the drug thermal vapor. These experiments may also be used to evaluate possible pulmonary toxicity of the thermal vapor. Because accurate extrapolation of these results to humans is facilitated if the test animal has a respiratory system similar to humans, mammals such as dogs or primates are a preferred group of test animals. Conducting such experiments in mammals also allows for monitoring of behavioral or physiological responses in mammals. Initial dose levels for testing in humans will generally be less than or equal to the least of the following: current standard intravenous dose, current standard oral dose, dose at which a physiological or behavioral response was obtained in the mammal experiments, and dose in the mammal model which resulted in plasma drug levels associated with a therapeutic effect of drug in humans. Dose escalation may then be performed in humans, until either an optimal therapeutic response is obtained or dose-limiting toxicity is encountered.

The actual effective amount of drug for a particular patient can vary according to the specific drug or combination thereof being utilized, the particular composition formulated, the mode of administration and the age, weight, and condition of the patient and severity of the episode being treated. The amount of drug to provide a therapeutic dose is generally known in the art or can be determined as discussed above.

The amount of drug to provide a therapeutic dose is generally known in the art or can be determined as discussed above. The required dosage, discussed above, and the determined film thickness of the instant methods (as set by the selected minimum aerosol purities and yield) dictate the minimum required substrate area in accord with the following relationship:
film thickness (cm)×drug density (g/cm³)×substrate area (cm²)=dose (g)

As noted above, drug density can be determined experimentally or from the literature, or if unknown, can be assumed to be 1 g/cc. To form a drug supply article comprising a drug film on a heat-conductive substrate that is capable of administering an effective human therapeutic dose, the minimum substrate surface area is determined using the relationships described above to determine a substrate area for a determined film thickness (according to the methods of the instant invention) that will yield a therapeutic dose of drug aerosol. Based on the necessity of accommodating a therapeutic amount of compound and the desire to form an aerosol with less than minimal amounts of degradation via vaporization, substrates having a surface area of less than 1 mm²/particle are not preferred. Table 1 shows a calculated substrate surface area for a variety of drugs on which an aerosol purity—film thickness profile was constructed.

TABLE 1

| | Typical Dose | Preferred Film | Calculated Substrate |
|---|---|---|---|
| Drug | (mg) | Thickness (μm) | Surface Area (cm²) |
| Albuterol | 0.2 | 0.1-10 | 0.2-20 |
| Alprazolam | 0.25 | 0.1-10 | 0.25-25 |
| Amoxapine | 25 | 2-20 | 12.5-125 |
| Atropine | 0.4 | 0.1-10 | 0.4-40 |
| Bumetanide | 0.5 | 0.1-5 | 1-50 |
| Buprenorphine | 0.3 | 0.05-10 | 0.3-60 |
| Butorphanol | 1 | 0.1-10 | 1-100 |
| Clomipramine | 50 | 1-8 | 62-500 |
| Donepezil | 5 | 1-10 | 5-50 |
| Hydromorphone | 2 | 0.05-10 | 2-400 |
| Loxapine | 10 | 1-20 | 5-100 |
| Midazolam | 1 | 0.05-20 | 0.5-200 |
| Morphine | 5 | 0.2-10 | 5-250 |
| Nalbuphine | 5 | 0.2-5 | 10-250 |
| Naratriptan | 1 | 0.2-5 | 2-50 |
| Olanzapine | 10 | 1-20 | 5-100 |
| Paroxetine | 20 | 1-20 | 10-200 |
| Prochlorperazine | 5 | 0.1-20 | 2.5-500 |
| Quetiapine | 50 | 1-20 | 25-500 |
| Rizatriptan | 3 | 0.2-20 | 1.5-150 |
| Sertraline | 25 | 1-20 | 12.5-250 |
| Sibutramine | 10 | 0.5-2 | 50-200 |
| Sildenafil | 6 | 0.2-3 | 20-300 |
| Sumatriptan | 3 | 0.2-6 | 5-150 |
| Tadalafil | 3 | 0.2-5 | 6-150 |
| Testosterone | 3 | 0.2-20 | 1.5-150 |
| Vardenafil | 3 | 0.1-2 | 15-300 |
| Venlafaxine | 50 | 2-20 | 25-250 |
| Zolpidem | 5 | 0.1-10 | 5-500 |
| Apomorphine | 2 | 0.1-5 | 4-200 |
| HCl | | | |
| Celecoxib | 50 | 2-20 | 25-250 |
| Ciclesonide | 0.2 | 0.05-5 | 0.4-40 |
| Eletriptan | 3 | 0.2-20 | 1.5-150 |
| Parecoxib | 10 | 0.5-2 | 50-200 |
| Valdecoxib | 10 | 0.5-10 | 10-200 |
| Fentanyl | 0.05 | 0.05-5 | 0.1-10 |

The actual dose of drug delivered, i.e., the percent yield or percent emitted, from the drug-supply article will depend on, along with other factors, the percent of drug film that is vaporized upon heating the substrate. Thus, for drug films that yield upon heating 100% of the drug film and aerosol particles that have 100% drug purity, the relationship between dose, thickness, and area given above correlates directly to the dose provided to the user. As the percent yield and/or particle purity decrease, adjustments in the substrate area can be made as needed to provide the desired dose. Also, as one of skill in the art will recognize, larger substrate areas other than the minimum calculated area for a particular film thickness can be used to deliver a therapeutically effective dose of the drug. Moreover as can be appreciated by one of skill in art, the film need not coat the complete surface area if a selected surface area exceeds the minimum required for delivering a therapeutic dose from a selected film thickness.

III. Methods of the Inventions

A. Method for Film Thickness Determination and a Defined Heating Temperature Determination by Selection of a Minimum Purity for a Thickness Followed by Yield Optimization via Temperature Selection

The present invention provides methods for determining a film thickness of a drug composition for use in forming an aerosol delivery article. In one aspect, the method entails determining film thickness and a defined heating temperature of the substrate for attaining a minimum selected purity and yield of the resultant aerosol and comprises the steps of:
(a) generating purity(es) of the drug composition in an aerosol formed by vaporizing the film from a substrate at one or more selected film thicknesses within a thickness range of about 0.05 and 50 microns at a selected temperature in the temperature range of about 150° C. to 550° C.,
(b) determining from said purity(es) if a defined thickness exists where the aerosol has a selected minimum purity,
(c) repeating steps (a) and (b), if necessary, for each of one or more different selected film thickness in the thickness range of about 0.05 to 50 microns until a defined thickness exists where the aerosol has the selected minimum purity,
(d) generating yields and purities of the drug composition in an aerosol formed by vaporizing the film of a selected thickness of the drug composition from a substrate at two or more different selected temperatures in the temperature range of about 150° C. to 550° C., or, at the same selected temperature in step (a) and one or more different selected temperatures in the temperature range of about 150° C. to 550° C.,
(e) determining from said yields and purities if a defined temperature exists where the aerosol formed has a selected minimum yield and a selected minimum purity, and
(f) repeating steps (d) and (e), if necessary, for each of one or more different temperatures in the temperature range of about 150° C. to 550° C. until a defined temperature exists where the aerosol has the selected minimum yield.

Drug composition aerosols are generated by volatilizing a drug composition film at one or more selected thicknesses from a heat-conductive and preferably, impermeable substrate at a selected temperature. The substrate is heated to vaporize the film, thereby producing aerosol particles containing the drug compound. In a preferred embodiment the films are prepared and volatilized according to Method B below. As one of skill in the art will appreciate, however, any method of volatilization from a metal substrate will work, however, volatilization with airflow is particularly preferred.

The selected film thickness can be any film thickness in the range of about 0.05 to 50 microns. Typically, the film thickness is initially selected based on (i) the amount of drug composition film needed to generate a therapeutic dose of the aerosol assuming 100% yield and purity, which can be determined as described above and (ii) the surface area to be coated on the substrate. For most drug compositions, initial selected film thickness selected are in the range of about 0.05 to 20 microns, more preferably in the range of 0.2 to about 10 microns, and most preferably in the range of 1 to about 5 microns. Thinner film thicknesses typically are preferred, because for a number of compounds, thinner coatings vaporize with less degradation, with the fraction of drug degradation products in the aerosol approximately linearly dependent on coating thicknesses

The temperature selected can be any temperature in the range of about 150° C. to 550° C. Typically, the temperature initially selected to heat the substrate for volatilization is lower for drugs of relatively low molecular weight, and higher for drugs of relatively high molecular weight. For example, drug composition of molecular weights less than about 250 Daltons, the temperature initially selected is typically around 280° C. or lower, whereas the temperature selected for a composition with a higher molecular weight is typically around 30° C. or greater. Additionally, the temperature selected is such that the drug composition is substantially completely volatized from the substrate within a period of 2 seconds, preferably, within 1 second and more preferably within 0.5 seconds and this will vary according to the drugs' vaporization properties and the film thickness selected. As one can appreciate, the specific temperature and film thickness(es) initially selected are not critical (as long as it is reasonably within the criteria set forth herein), rather it is the relationship between the purity(es) and the selected film thickness(es) for the specific drug composition being vaporized that is important.

The film is then volatilized and the generated aerosol collected. The aerosol may be collected in particle form or simply collected on the walls of a surrounding container. The purity of the drug composition is then determined, as described above and expressed as a weight percent or analytical percent drug degradation product. As one of skill in the art will appreciate, yield data may also be determined. The purity data is then analyzed to determine if a selected minimum purity exists for the aerosol. The selected minimum purity can be any number from 1-100%. However, for applications involving use of the resultant aerosol as a therapeutic, preferably the selected minimum purity is at least 90%, more preferably at least 95%, and most preferably at least 98%.

One way to express the dependence of aerosol purity on film thickness is by the slope of the line from a plot of aerosol purity against film thickness. Assuming a uniform thin coating of thickness λ being vaporized to completion at fixed temperature (at a constant net vaporization rate per unit surface area, Vₙₑₜ), the time necessary for complete vaporization (t_{c}) is λ/Vₙₑₜ. Then for 0^{th} order degradation processes and in the small degradation limit of higher order reactions, the concentration of a degradant formed [D] is linear in time ([D]≈A*k*t, where A is a constant dependent on the reaction order and k is the reaction rate constant). Thus [D]≈A*k*λ/Vₙₑₜ, i.e., the degradant concentration is approximately a linear function of the initial coating thickness.

For a number of drug compositions, this linear relationship has been shown to exist. Thus, based on the purity data, one can determine if a thickness exists for a selected minimum purity if the selected minimum purity fell within the purity data points, or if the selected minimum purity did not fall between or on the data points collected, the data could be extrapolated out linearly to determine if a defined film thickness existed for a selected minimum purity. This analysis could be done visually, by plotting, or by use of any other analysis means known by those of skill in the art, including use of computer programs. For those drug compositions, which exhibited significantly increasing amounts of drug degradation products at very thin film thickness, but a linear plot for purity data versus film thickness after reaching some maximum on the curve, the slope of the line was taken from the maximum point in the curve towards the higher film thickness. Alternatively, if the defined thickness was not determined for the selected minimum purity for the tested thicknesses, and in particular, for drug compositions where a linear relationship was not observed, additional film thicknesses were tested. Generally, if the percent drug degradation product was above a selected threshold, e.g., 1, 2, 5, or 10 percent, the steps above are repeated with different drug composition thicknesses in the range of about 0.05 to 50 microns, typically with successively lower thicknesses, until the aerosolized drug composition is within the desired limit of degradation, e.g., 1, 2, 5, or 10%.

Upon determining that a defined thickness existed, this defined film thickness was then volatilized at at least two or more different selected temperatures in the range of about 150° C. to 550° C. or, alternatively at the temperature used to determine the defined thickness and at least one additional different temperature. In the studies described herein, the yields and purities were determined, by methods described herein. For example, the percentage of drug film vaporized was determined by quantifying (primarily by HPLC or weight) the mass of drug composition collected upon vaporization or alternatively by the amount of substrate mass decrease. The mass of drug composition collected after vaporization and condensation was compared with the starting mass of the drug composition film that was determined prior to vaporization to determine a percent yield, also referred to herein as a percent emitted. This value is indicated in many of the Examples set forth below. For example, in one of the studies in Example 1, a film having a thickness of 1.3 μm was formed from the drug alprazolam, an anti-anxiety agent. The mass coated on the substrate was 0.833 mg and the mass of drug collected in the thermal vapor was 0.096 mg, to give an 11.5 percent yield. After vaporization, the substrate was washed to recover any remaining drug. The total drug recovered from the test apparatus, including the emitted thermal vapor, was 0.821 mg, to give a 98.6% total recovery.

These data were then analyzed to determine if a defined temperature existed where the aerosol formed had a selected minimum yield. The minimum selected yield can be any number from 1% to 100%. However, for applications involving delivery of the resultant aerosol in a commercial device for a therapeutic application, preferably the selected minimum yield is at least 50%, more preferably at least 75%, still more preferably at least 85%, and most preferably at least 90%.

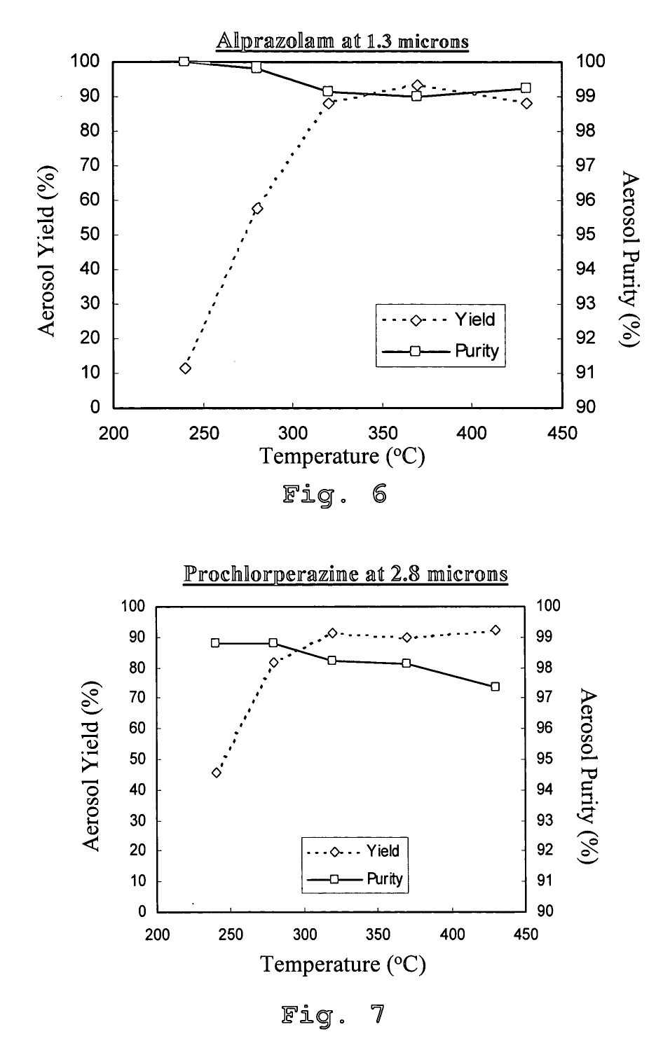

The analysis of the effect of temperature on yield and purity can be done visually, by plotting, or by use of any other analysis means known by those of skill in the art, including use of computer programs. Typically, however, the analyses of the studies conducted in support of the invention were done by plotting for a particular thickness, aerosol yield data versus temperature and aerosol purity data versus temperature on the same graph to determine temperatures at which at least the selected minimum and purity is obtained, as is shown for some representative drug compositions in FIGS. 6-11 that were volatilized and analyzed as described in Examples 1-6. One can readily determine visually from such plots if a defined heating temperature exists (minimum substrate heating temperature at which the minimum selected yield and minimum selected purity were attained) and/or if a temperature window exists (range of consecutive substrate temperatures over which at least the selected minimum purity and selected minimum yield were met).

Thus, for example, if the selected minimum yield was 50% and the selected minimum purity was 90% for alprazolam at a defined thickness of 1.3 microns, then the defined heating temperature would be ˜270° C. as shown in FIG. 6, whereas, the temperature window would range from ˜270° C. to at least 425° C. If, however, the selected minimum yield was at least 85%, then the defined heating temperature increase to ˜320° C. as shown in FIG. 6, whereas, the temperature window would range from ˜320° C. to at least 425° C.

If the data indicate that no defined heating temperature exists for the minimum selected yield, the step above involving the heating of the drug composition at different temperatures is repeated. Typically, if insufficient yield is obtained at the tested temperatures, the heating temperature is increased to determine if selected minimum yield can be obtained without decreasing the purity level below the minimum selected purity.

On the other hand, if the initial volatilization studies show very low levels of degradation, e.g., less than 0. 1, 1, 2, or 5% and very high aerosol yields, it may be desirable in subsequent tests to adjust the film thickness, to obtain a greater or a greatest film thickness at which an acceptable level of drug degradation is observed and the selected minimum yield is attained. That is, a substrate having an adjusted film thickness is heated and the percent purity and percent yield are determined. The film thickness is continually adjusted until the desired drug composition aerosol purity and yield are achieved.

This scenario is advantageous for two reasons (i) the minimal surface area of substrate needed in forming the aerosol delivery article can potentially be lessened, and/or (ii) the flexibility in forming the aerosol delivery article would be greater, as more variability in the film thickness and the temperature at which the substrate was heated would be tolerable without compromising the ability to maintain a selected minimal purity and yield level.

As one of skill in the art will appreciate, while thickness is a primary factor controlling purity, other factors that can be used to improve yields and purity may also be further incorporated into the methods of the invention, or done subsequent to or prior to the methods of the invention to improve the yield or purity. These factors include, for example, and not limitation, modifying the structure or form of the drug, producing the thermal vapor in an inert atmosphere, adjusting the air flow rate, adjusting the rate of heating, and/or, as discussed above, using a treated substrate surface.

Thus, use of an altered form of the drug, such as, use of a pro-drug, or a free base, free acid or salt form of the drug may be used concomitant with the methods of the invention or afterwards to increase yet higher the purity or yield of the aerosol particles. Although not always the case, the free base or free acid form of the drug as opposed to the salt, generally results in either a higher purity or yield of the resultant aerosol. Thus, in a preferred embodiment of the invention, the free base and free acid forms of the drugs are used in the methods of the invention.

Additionally, generation of drug-aerosol particles having a desired level of drug composition purity can be generated by forming the thermal vapor under a controlled atmosphere of an inert gas, such as argon, nitrogen, helium, and the like.

After identification of the film thickness that generates a highly pure thermal drug composition vapor (e.g., drug composition purity greater than about 90%), and a high yield of aerosol, typically 50% yield, more preferably 75%, still more preferably 85%, and most preferably 90%, the substrate surface area for which this film thickness yields an effective human therapeutic dose can be selected for forming the aerosol delivery article. Selection of substrate surface areas between about 0.05 to about 100 cm² are particularly preferred for incorporation of the article into a commercial embodiment.

B. Method for Film Thickness Determination by a Contemporaneous Determination of Purity and Yield

In another aspect of the invention, a method is provided for determining a film thickness of a drug composition to be aerosolized from a film on a substrate, for use in forming an aerosol delivery article, comprising:
(a) acquiring yields and purities of the drug composition in an aerosol formed by vaporizing the film from the substrate as a function of film thickness and temperature, at two or more selected temperatures within a temperature range of about 250° C. to 550° C. and two or more selected film thicknesses within a thickness range of about 0.05 and 50 microns,
(b) determining from said yields and purities if a thickness and temperature exist where the aerosol has at least 90% purity and at least 50% yield; and
(c) repeating step (a), if necessary, for each of one or more different selected film thickness in the thickness range of about 0.05 to 50 microns, or one or more different selected temperatures in the temperature range of about 150° C. to 550° C., respectively, until the purity and yield in (b) are met.

This method has an advantage over the preceding method discussed above in that the thickness is determined by acquiring the yield and purity data corresponding to the various film thickness and temperature, at the same time, for purposes of determining a film thickness for forming an aerosol generating device. Additionally, this method in contrast to the previous method allows one to determine a thickness window (range of consecutive thicknesses over which at least the criteria for a selected minimum purity and selected minimum yield are met).

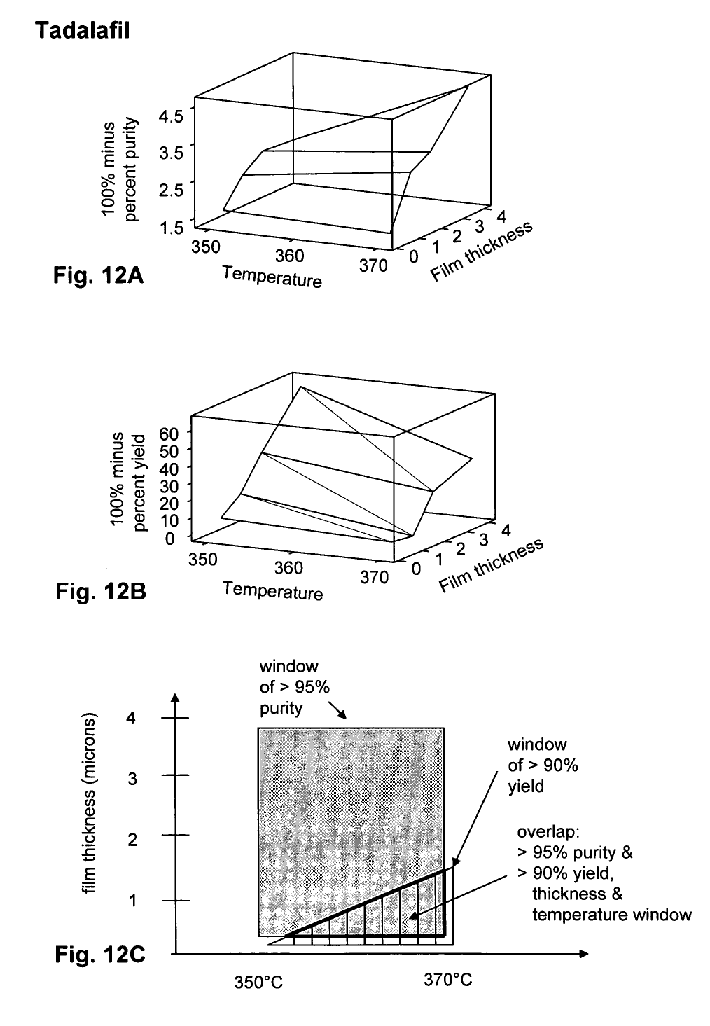

Furthermore, with this method, thickness and temperature windows for minimum selected purities and yields can be determined. A thickness and temperature window is a range of consecutive thicknesses and a range of consecutive temperatures over which at least a selected minimum purity or greater is attained, and over which at least a selected minimum yield or greater is attained. Preferred selected minimum purities are at least 90% and preferred selected minimum yield are 50%. Examples of thickness and temperature windows are illustrated in FIGS. 12C-19C, and will be discussed further below.

As was discussed in the preceding method, the selected film thickness can be any film thickness in the range of about 0.05 to 50 microns. Typically, one of the film thicknesses is initially selected based on (i) the amount of drug composition film needed to generate a therapeutic dose of the aerosol assuming 100% yield and purity, which can be determined as described above and (ii) the surface area to be coated on the substrate. For most drug compositions, initial selected film thickness selected are in the range of about 0.05 to 20 microns, more preferably in the range of 0.2 to about 10 microns, and most preferably in the range of 1 to about 5 microns. Thinner film thicknesses typically are preferred, because for a number of compounds, thinner coatings vaporize with less degradation, with the fraction of drug degradation products in the aerosol approximately linearly dependent on coating thicknesses. Additional film thickness for testing are typically selected such that the thickness range over which the yields and purities of the drug composition are acquired covers a micron range of at least 1 micron, preferable 2 microns, and more preferably 5 microns.

Likewise, as was discussed in the previous method, the temperatures selected can be any temperatures in the range of about 150° C. to 550° C. Typically, the temperature initially selected to heat the substrate for volatilization is lower for drugs of relatively low molecular weight, and higher for drugs of relatively high molecular weight. For example, drug composition of molecular weights less than about 250 Daltons, the temperature initially selected is typically around 280° C. or lower, whereas the temperature selected for a composition with a higher molecular weight is typically around 320° C. or greater. Additionally, the temperature selected is such that the drug composition is substantially completely volatized from the substrate within a period of 2 seconds, preferably, within 1 second and more preferably within 0.5 seconds and this will vary according to the drugs' vaporization properties and the film thickness selected. Additional temperatures for testing are typically selected such that the temperature range over which the yields and purities of the drug composition are acquired covers a degree range of at least 30 degrees ° C., preferable at least 50 degrees ° C., and more preferably at least 90 degrees ° C.

For the purposes of forming an aerosol delivery article, the minimum selected purity is typically at least 90%, more preferably at least 95%, and most preferably at least 98%, whereas the minimum selected yield is typically at least 50%, more preferably at least 75%, still more preferably at least 85%, and most preferably at least 90%.

Typically, for purposes of determining if a temperature and thickness exists, where the aerosol has at least a selected minimum purity and a selected minimum yield, the data is analyzed directly through visual analysis; or by plotting percent yield (or 100% minus percent yield) versus the temperature versus thickness and percent purity (or 100% minus percent purity) versus temperature versus thickness on graphs and determining overlap (See FIGS. 12A-19A, 12B-19B); or by plotting purity versus temperature versus film thickness for a selected minimum purity (referred to herein as a purity window) and plotting yield versus temperature versus film thickness (referred to herein as a yield window) for a selected minimum yield and overlapping these purity and yield windows to determine if a thickness and temperature window exists for such desired purity and thickness (See FIGS. 12C-19C).

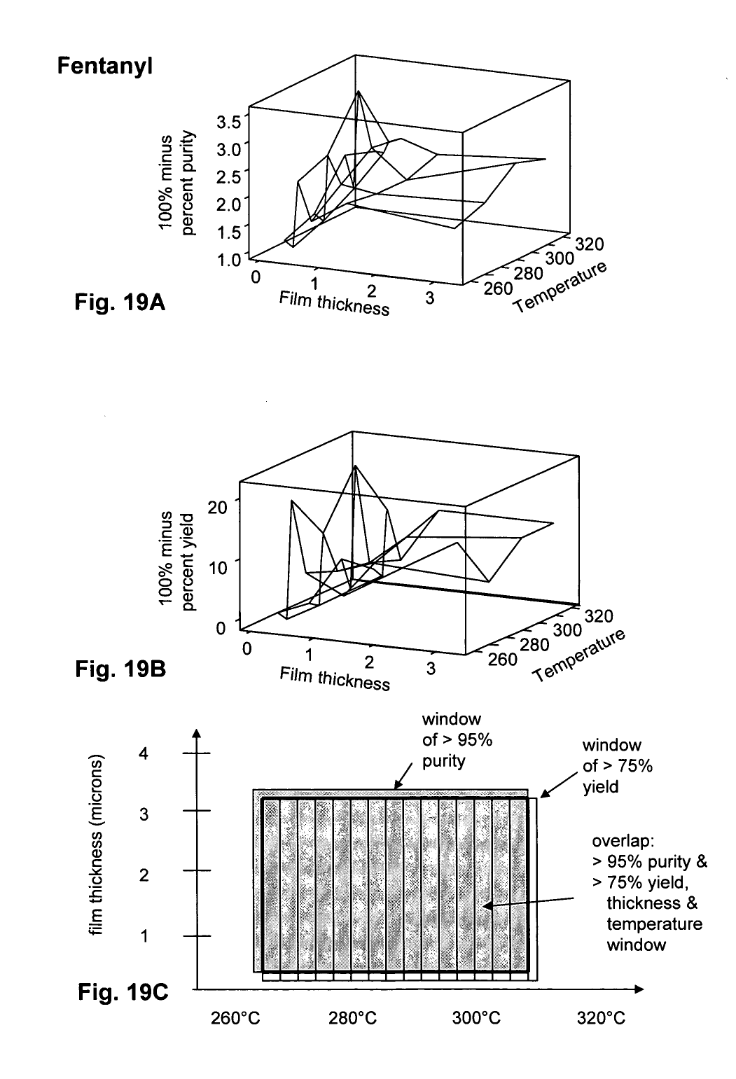

Examples 7-14 are illustrative of this method. The yield and purity data for various drug compositions were acquired and determined as described above and in the Examples. This data was then plotted using Minitab Statistical Software by MINITAB to generate the 3-D plots in FIGS. 12-19. By inserting a plane through the minimum selected 100% minus percent purity or 100% minus percent yield data in these plots, one can readily determine the range of purities and film thickness that would meet the minimum selected purity or yield. Alternatively, the data can be plotted as purity windows and yield windows for a selected minimum purity and yield, respectively. (See FIGS. 12C-19C). Any overlap of these windows indicates the thickness and temperature ranges suitable for forming an aerosol delivery article that meets the selected minimum purity and yield. For example, fentanyl was prepared as described in Example 14. The purity and yield data was plotted as a function of temperature and film thickness as shown in FIGS. 19A-19B. A thickness and temperature window of greater than 95% purity and greater than 75% yield was determined to span a film thickness range of approximately 0.3 microns to 3.3 microns and temperatures of about 260° C. to about 310° C.

In the event that no thickness and temperature exists where the resultant aerosol from volatilization of the drug compositions has at least 90% purity and at least 50% yield, the process becomes iterative, if necessary. Yields and purities for each of one or more different selected film thickness in the range of 0.05 to 50 microns, or one or more different temperature in the temperature range of about 150° C. to 550° C., can be acquired until the desired purity and yield is attained. Thus the film thickness or temperature is continually adjusted until the desired drug composition aerosol purity and yield are achieved. Typically, if the purity attained is less than 90%, then during the iterative process a thinner film thickness is selected for testing. If the percent yield is less than about 50%, the thickness of the drug film is adjusted to a thickness different from the initial film thickness for testing or the temperature is adjusted. That is, a substrate having the same film thickness or an adjusted film thickness is heated to an adjusted temperature or the same temperature, respectively, and the percent purity and percent yield are determined. If the less than 50% yield obtained is due to incomplete volatilization of the drug composition film (as can be determined by the total amount of drug composition recovered from the aerosol and the film), typically the temperature is adjusted and selected to be higher than those tested in step (a) of the method or the film thickness is selected to be thinner. If the less than 50% yield obtained is due to large amounts of drug degradation, then either the temperature is decreased or the film thickness is decreased.

In one preferred embodiment acquiring the yields and purities as a function of film thickness and temperature involves (i) depositing on a substrate a film of the drug composition having a selected thickness in the thickness range of about 0.05-50 microns, (ii) heating the substrate to a selected temperature in the temperature range of about 150° C.-550° C., to vaporize the film, (iii) collecting the aerosol formed from the vaporized drug composition, (iv) determining the percent yield and percent purity of drug composition in the collected aerosol, and (v) repeating steps (i)-(iv) for one or more different selected temperatures in the temperature range of about 150° C. to 550° C. and one or more different selected film thicknesses in the thickness range of about 0.05 and 50 microns.

In this embodiment of the method, a drug film with a known film thickness is prepared on a heat-conductive, impermeable substrate. The substrate is heated to vaporize the film, thereby producing aerosol particles containing the drug compound. The drug composition purity of the aerosol particles in the thermal vapor is determined, as well as the percent yield, i.e., the fraction of drug composition film vaporized and delivered by the method.

In other embodiments, acquiring the yields and purities as a function of film thickness and temperature can involve obtaining such data from the literature or others and/or a combination of obtaining such data from the literature and for at least one selected thickness and selected temperature, (i) depositing on a substrate a film of the drug composition having a selected thickness in the thickness range of about 0.05-50 microns, (ii) heating the substrate to a selected temperature in the temperature range of about 150° C.-550° C., to vaporize the film, (iii) collecting the aerosol formed from the vaporized drug composition, (iv) determining the percent yield and percent purity of drug composition in the collected aerosol.

Another embodiment of the invention includes determining if a thickness window exists over which the aerosol has at least a selected minimum purity and a selected minimum yield. This can readily be determined by directly analyzing, by plotting the yield and purity data at various thicknesses, or by use of computer analysis programs. Preferably, for forming an aerosol delivery device, the selected minimum purity is at least 90% and the selected minimum yield is at least 50%, and a thickness window of at least 1 micron exists, more preferably a thickness window of at least 2 microns exists, most preferably a thickness window of at least 5 microns or greater exists.

Similarly, yet another embodiment of the invention includes determining if a temperature window exists over which the aerosol has at least selected minimum purity and a selected minimum yield. Again, this can be determined by directly analyzing the data, by plotting the yield and purity data at various thicknesses, or by use of computer analysis programs. Preferably, for forming an aerosol delivery device, the selected minimum purity as stated in the previous embodiment is at least 90% and the selected minimum yield is at least 50%. Likewise in preferred embodiments, a temperature window of at least 20 degrees ° C. exists, more preferably a temperature window of at least 40 degrees ° C. exists, most preferably a temperature window of at least 80 degrees ° C. or greater exists.

As was discussed with the previous method, other factors that can be used to improve yields and purity may also be further incorporated into the methods of the invention, or done subsequent to or prior to the methods of the invention to improve the yield or purity.

After identification of the film thickness that generates a highly pure thermal drug composition vapor and the selected minimum yield of aerosol, this information can be used to determine, as discussed above, the substrate surface area for which this film thickness yields an effective human therapeutic dose.

I. Utility/Application

As can be appreciated from the above discussion and the examples showing generation of a pure drug thermal vapor, from thin films (i.e. 0.05-50 μm) of the drug, the invention finds use in the medical field in compositions and articles for delivery of a therapeutic. The methods are particularly suitable for forming articles use in devices for inhalation therapy, but are also applicable for any aerosol device that generates a gas stream, for application of drug-aerosol particles to a target site.

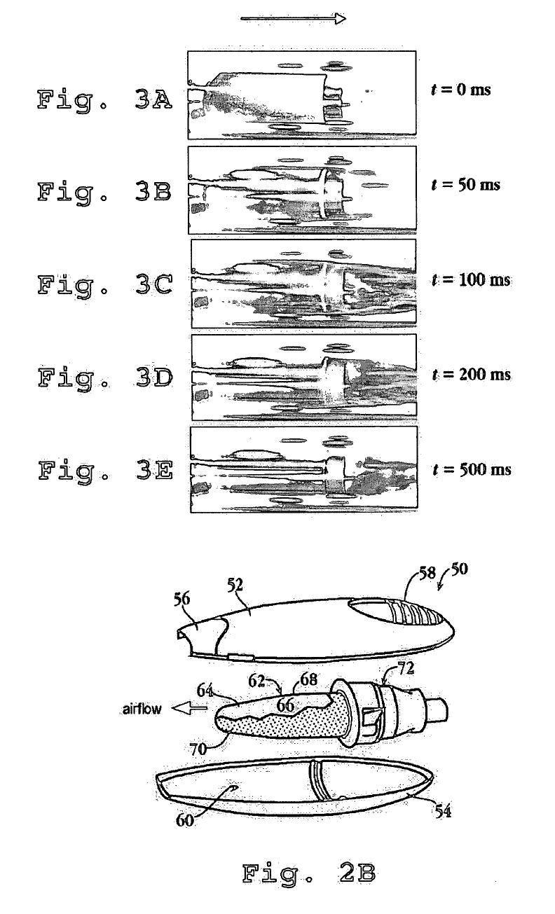

As an illustrative example only, and not for limitation, is shown an aerosol device, in a perspective view in FIG. 2A, that incorporates an aerosol delivery article, similar to that shown in FIG. 1B, and that is formed using the methods of the invention for determining film thickness. Device 30 includes a housing 32 with a tapered end 34 for insertion into the mouth of a user. On the end opposite tapered end 34, the housing has one or more openings, such as slot 36, for air intake when a user places the device in the mouth and inhales a breath. Disposed within housing 32 is an aerosol delivery article 38, visible in the cut-away portion of the figure. The aerosol delivery article includes a substrate 40 coated with a film 42 of a therapeutic drug to be delivered to the user. The aerosol delivery article can be rapidly heated to a temperature sufficient to vaporize all or a portion of the film of drug to form a drug vapor that becomes entrained in the stream of air during inhalation, thus forming the drug-aerosol particles. Heating of the aerosol delivery article is accomplished by, for example, an electrically-resistive wire embedded or inserted into the substrate and connected to a battery disposed in the housing. Substrate heating can be actuated by a user-activated button on the housing or via breath actuation, as is known in the art.

FIG. 2B shows another drug-delivery aerosol device that incorporates an aerosol delivery article, again where the article comprises a substrate and a film, and where the device components are shown in unassembled form. Inhalation device 50 is comprised of an upper external housing member 52 and a lower external housing member 54 that fit together. The downstream end of each housing member is gently tapered for insertion into a user's mouth, best seen on upper housing member 52 at downstream end 56. The upstream end of the upper and lower housing members are slotted, as seen best in the figure in the upper housing member at 58, to provide for air intake when a user inhales. The upper and lower housing members when fitted together define a chamber 60. Positioned within chamber 60 is an aerosol delivery article 62, shown in a partial cut-away view. The aerosol delivery article has a tapered, substantially cylindrical metal substrate 64 coated with a film 66 of drug on its treated exterior surface 68. Visible in the cut-away portion of the aerosol delivery article is an interior region 70 of the substrate containing a substance suitable to generate heat. The substance can be a solid chemical fuel, chemical reagents that mix exothermically, electrically resistive wire, etc. A power supply source, if needed for heating, and any necessary valving for the inhalation device are contained in end piece 72.

Typically devices incorporating an aerosol delivery article also include a gas-flow control valve disposed upstream of the article for limiting gas-flow rate through the condensation region to the selected gas-flow rate, for example, for limiting air flow through the chamber as air is drawn by the user's mouth into and through the chamber. In one type of device, the gas-flow valve may include an inlet port communicating with the chamber, and a deformable flap adapted to divert or restrict air flow away from the port increasingly, with increasing pressure drop across the valve. In another device, the gas-flow valve may include an actuation switch, with valve movement in response to an air pressure differential across the valve acting to close the switch. In still another device, the gas-flow valve may include an orifice designed to limit airflow rate into the chamber.

The devices having an aerosol delivery article formed using the methods of the invention may also include a bypass valve communicating with the chamber downstream of the unit for offsetting the decrease in airflow produced by the gas-flow control valve, as the user draws air into the chamber. The bypass valve cooperates with the gas-control valve to control the flow through the condensation region of the chamber as well as the total amount of air being drawn through the device. Thus the total volumetric airflow through the device, is the sum of the volumetric airflow rate through the gas-control valve, and the volumetric airflow rate through the bypass valve. The gas control valve acts to limit air drawn into the device to a preselected level, e.g., 15 L/minute, corresponding to the selected air-flow rate for producing aerosol particles of a selected size. Once this selected airflow level is reached, additional air drawn into the device creates a pressure drop across the bypass valve which then accommodates airflow through the bypass valve into the downstream end of the device adjacent the user's mouth. Thus, the user senses a full breath being drawn in, with the two valves distributing the total airflow between desired airflow rate and bypass airflow rate.

These valves may be used to control the gas velocity through the condensation region of the chamber and hence to control the particle size of the aerosol particles produced by vapor condensation. More rapid airflow dilutes the vapor such that it condenses into smaller particles. In other words, the particle size distribution of the aerosol is determined by the concentration of the compound vapor during condensation. This vapor concentration is, in turn, determined by the extent to which airflow over the surface of the heating substrate dilutes the evolved vapor. Thus, to achieve smaller or larger particles, the gas velocity through the condensation region of the chamber may be altered by modifying the gas-flow control valve to increase or decrease the volumetric airflow rate. For example, to produce condensation particles in the size range 1-3.5 μm MMAD, the chamber may have substantially smooth-surfaced walls, and the selected gas-flow rate may be in the range of 4-50 L/minute.

Additionally, as will be appreciated by one of skill in the art, particle size may be also altered by modifying the cross-section of the chamber condensation region to increase or decrease linear gas velocity for a given volumetric flow rate, and/or the presence or absence of structures that produce turbulence within the chamber. Thus, for example, to produce condensation particles in the size range 20-100 nm MMAD, the chamber may provide gas-flow barriers for creating air turbulence within the condensation chamber. These barriers are typically placed within a few thousands of an inch from the substrate surface. Typically, the flow rate of gas over the substrate ranges from about 4-50 L/min, preferably from about 5-30 L/min.

The heat source in the aerosol devices, as discussed above, is typically effective to supply heat to the substrate at a rate that achieves a substrate temperature of at least 150° C., preferably at least 250 ° C., or more preferably at least 300° C. or 350° C., and produces substantially complete volatilization of the drug composition from the substrate within a period of 2 seconds, preferably, within 1 second, or more preferably within 0.5 seconds. Particularly, suitable heat sources are those which are supplied current at a rate sufficient to achieve rapid heating, e.g., to a substrate temperature of at least 150° C., 250° C., 300° C., or 350° C. preferably within 50-500 ms, more preferably in the range of 50-200 ms.

FIGS. 3A-3E are high speed photographs showing the generation of aerosol particles from an aerosol delivery article. FIG. 3A shows a stainless steel substrate about 2 cm in length coated with a film of drug. Prior to drug coating, the steel substrate was heated about three times in air to a temperature of approximately 400° C. for a period of approximately 2 seconds to form a metal-oxide enriched exterior coating. The drug-coated substrate was placed in a chamber through which a stream of air was flowing in an upstream-to-downstream direction (indicated by the arrow in FIG. 3A) at rate of about 15 L/min. The substrate was electrically heated and the progression of drug vaporization monitored by real-time photography. FIGS. 3B-3E show the sequence of drug vaporization and aerosol generation at time intervals of 50 milliseconds (msec), 100 msec, 200 msec, and 500 msec, respectively. The white cloud of drug-aerosol particles formed from the drug vapor entrained in the flowing air is visible in the photographs. Complete vaporization of the drug film was achieved by 500 msec.

The aerosol delivery articles formed from the methods of the inventions also has application for generating a therapeutic inhalation dose of drug-aerosol particles. The inhalation route of drug administration offers several advantages for many drugs, including rapid uptake into the bloodstream, and avoidance of the first pass effect allowing for an inhalation dose of a drug that can be substantially less, e.g., one half, that required for oral dosing. Efficient aerosol delivery to the lungs requires that the particles have certain penetration and settling or diffusional characteristics. For larger particles, deposition in the deep lungs occurs by gravitational settling and requires particles to have an effective settling size, defined as mass median aerodynamic diameter (MMAD), of between 1-3.5 μm. For smaller particles, deposition to the deep lung occurs by a diffusional process that requires having a particle size in the 10-100 nm, typically 20-100 nm range. Particle sizes that fall in the range between 100 nm and 1 μm tend to have poor deposition and those above 3.5 μm tend to have poor penetration. Therefore, an inhalation drug aerosol device for deep lung delivery should produce an aerosol having particles in one of these two size ranges, preferably between about 1-3 μm MMAD. The aerosol delivery articles formed from the methods of the invention have this capability. Not only can the particle size be controlled, but also since the methods of the invention allow control of the yield and purity of the aerosol particles, a substrate area can be determined and used in the device that is sufficient to deliver a therapeutic inhalation dose of drug aerosol particles.

Thus, the methods of the invention have applications in the medical delivery field, and in particular, for use in forming articles for inhalation aerosol devices as well as other topical aerosol devices.

### V. EXAMPLES

The following examples describe specific aspects of the invention to illustrate the invention and to provide a description of the methods for those of skill in the art. The examples should not be construed as limiting the invention, as the examples merely provide specific methodology useful in understanding and practicing the invention.

### Materials

Solvents were of reagent grade or better and purchased commercially.

Unless stated otherwise, the drug free base or free acid form was used in the Examples.

### Methods

Unless stated otherwise, all temperatures measured and reported as peak substrate temperatures were measured with an infrared camera (FLIR Thermacam SC3000).

A. Preparation of Drug-Coating Solution

Drug was dissolved in an appropriate solvent. Common solvent choices included methanol, acetone, dichloromethane, methyl ethyl ketone, diethyl ether, 3:1 chloroform:methanol mixture, 1:1 dichloromethane: methyl ethyl ketone mixture, dimethylformamide, and deionized water. Sonication and/or heat were used as necessary to dissolve the compound. The drug concentration was typically between 50-200 mg/mL.

B. Preparation of Drug-Coated Stainless Steel Foil Substrate

Strips of clean 304 stainless steel foil (0.0125 cm thick, Thin Metal Sales) having dimensions 1.3 cm by 7.0 cm were dip-coated with a drug solution. The foil was then partially dipped three times into solvent to rinse drug off of the last 2-3 cm of the dipped end of the foil. Alternatively, the drug coating from this area was carefully scraped off with a razor blade. The final coated area was between 2.0-2.5 cm by 1.3 cm on both sides of the foil, for a total area of between 5.2-6.5 cm². Some foils were prepared as stated above and then directly extracted with methanol or acetonitrile. The amount of drug was determined from quantitative HPLC analysis. Using the known drug-coated surface area, the thickness was then obtained by:
film thickness (cm)=drug mass (g)/[drug density (g/cm³)×substrate area (cm²)].
If the drug density is not known, a value of 1 g/cm³ is assumed. The film thickness in microns is obtained by multiplying the film thickness in cm by 10,000.

After drying, the drug-coated foil was placed into a volatilization chamber constructed of a Delrin® block (the airway) and brass bars, which served as electrodes. The dimensions of the airway were 1.3 high by 2.6 wide by 8.9 cm long. The drug-coated foil was placed into the volatilization chamber such that the drug-coated section was between the two sets of electrodes. After securing the top of the volatilization chamber, the electrodes were connected to a 1 Farad capacitor (Phoenix Gold). The back of the volatilization chamber was connected to a two micron Teflon® filter (Savillex) and filter housing, which were in turn connected to the house vacuum. Sufficient airflow was initiated (typically 30 L/min=1.5 m/sec), at which point the capacitor was charged with a power supply, typically to between 14-17 Volts. The circuit was closed with a switch, causing the drug-coated foil to resistively heat to temperatures of about 280-430° C., in about 200 milliseconds. (For comparison purposes, see FIG. 4A, thermocouple measurement in still air.) After the drug had vaporized, airflow was stopped and the Teflon® filter was extracted with acetonitrile or methanol. Drug extracted from the filter was analyzed by HPLC. UV absorbance at 225 nm using a gradient method aimed at detection of impurities to determine percent purity. Also, the extracted drug was quantified to determine a percent yield, based on the mass of drug initially coated onto the substrate. A percent recovery was determined by quantifying any drug remaining on the substrate, adding this to the quantity of drug recovered in the filter and comparing it to the mass of drug initially coated onto the substrate.

C. General Method I for Determining Film Thickness

A solution of the drug was prepared as described in Method A. Typically a concentration of 50 or 100 mg/mL was chosen, depending on the initial amount and solubility limits of the drug compound. Foils were coated at one or more thicknesses with drug compound and a subset of these foils were extracted as coating standards as discussed in Method B.

An initial vaporization temperature was selected. Typically, for drugs of relatively low molecular weight, less than 250 Daltons for example, 14 Volts was selected as the discharge voltage for the 1 F capacitor. For higher molecular weight compounds, typically 15 Volts was selected.

After vaporization of the drug at the first voltage setting, using the vaporization protocol described in Method B, the foil was inspected and the purity and yield of the aerosol formed was determined. Generally as a guide, if the drug was completely vaporized from the substrate, the voltage was typically decreased by 0.5 V for the next experiment. If the drug appeared to be mostly vaporized off the foil substrate but not completely, typically the voltage would be increased by 0.5 V for the next experiment. If little or no drug appeared to have vaporized off the foil substrate, the voltage would typically be increased by 1.0 V for the next experiment. Subsequent increases or decreases in the voltage and hence temperature, were undertaken as needed to obtain the minimum selected yield.

Likewise, thinner or thicker drug coatings were chosen and tested, depending on the purity and yield results obtained. Generally, if the purity and yield were acceptable, the drug coating solution was typically concentrated to form a thicker drug coating on the foil substrates. Alternatively, if the purity or yield was not acceptable, the drug coating solution was diluted to form thinner drug coatings on the foil substrates.

The data on yield and purity were analyzed at one or more thickness and multiple temperatures to determine if a defined temperature and/or range of temperatures above the defined temperature and a thickness existed at which the aerosol had at least a minimum selected purity and yield. Typically, the data was analyzed directly through visual analysis or by plotting for a particular thickness, aerosol yield data versus temperature and aerosol purity data versus temperature on the same graph to determine areas of overlap. For reasons discussed above, a linear relationship between data points was assumed for purposes of plotting the data. Alternatively, other analysis means could be used such as, for example, computer analysis of the data.

D. General Method II for Determining Film Thickness

Various solutions of the drug were prepared as described in Method A. Typically concentrations in the range of 50 or 100 mg/mL were chosen, depending on the initial amount and solubility limits of the drug. Foils were coated at multiple thicknesses with drug compound and a subset of these foils were extracted as coating standards as discussed in Method B.

Two or more vaporization temperatures were selected. Typically, for drugs of relatively low molecular weight, less than 250 Daltons for example, 14 Volts was selected as one of the discharge voltages for the 1 F capacitor. For higher molecular weight compounds, typically 15 Volts was selected as one of the discharge voltages.

After vaporization of the foils at the multiple voltage settings, using the vaporization protocol described in Method B, the purities and yields of the aerosols formed were determined.

The data on yield and purity were analyzed to determine if a thickness and temperature and/or a range of thicknesses and temperatures existed at which the aerosol had at least a minimum selected purity and yield. Typically, the data was analyzed directly through visual analysis; or by plotting percent yield (or 100% minus percent yield) versus the temperature versus thickness and percent purity (or 100% minus percent purity) versus temperature versus thickness on graphs and determining overlap; or by plotting purity versus temperature versus film thickness for a selected minimum purity (referred to herein as a purity window) and plotting yield versus temperature versus film thickness (referred to herein as a yield window) for a selected minimum yield and overlapping these purity and yield windows to determine if a thickness and temperature window exists for such selected minimum purity and thickness. As discussed above, a linear relationship between data points was assumed for purposes of plotting the data. Alternatively, other analysis means could be used such as, for example, computer analysis of the data.

If necessary, to obtain a desired purity and yield, additional thicknesses and/or temperatures were tested.

### Example 1

Using a solution of 100 mg/mL alprazolam in dichloromethane, stainless steel foils were coated (˜1.3 microns thick) and vaporized as described in Method B. The data were obtained and analyzed as described in Method C by varying the capacitor discharge voltage between 13 and 17 Volts, which results in peak substrate temperatures of 240 and 430° C., respectively.

For the substrate vaporized at 13 V, 0.833 mg of drug was applied to the substrate. After volatilization of drug from this substrate, 0.096 mg was recovered from the filter, for a percent yield of 11.5%. Purity of the drug aerosol particles was >99.9%. A total mass of 0.821 mg was recovered from the test apparatus and substrate, for a total recovery of 98.6%.

For the substrate vaporized at 16 V, 0.833 mg of drug was applied to the substrate. After volatilization of drug from this substrate, 0.777 mg was recovered from the filter, for a percent yield of 93.4%. Purity of the drug aerosol particles was 99.0%. A total mass of 0.805 mg was recovered from the test apparatus and substrate, for a total recovery of 96.6%.

FIG. 6 is a plot of the purity and yield data as a function of temperature for a 1.3 micron film thickness of alprazolam. Most points represent the average of several experiments at the same voltage.

### Example 2

Using a solution of 125 mg/mL prochlorperazine in acetone, stainless steel foils were coated (˜2.8 microns thick) and vaporized as described in Method B. The data were obtained and analyzed as described in Method C by varying the capacitor discharge voltage between 13 and 17 Volts, which results in peak substrate temperatures of 240 and 430 ° C., respectively.

For the substrate vaporized at 13 V, 1.540 mg of drug was applied to the substrate. After volatilization of drug from this substrate, 0.704 mg was recovered from the filter, for a percent yield of 45.7%. Purity of the drug aerosol particles was 98.8%. A total mass of 1.501 mg was recovered from the test apparatus and substrate, for a total recovery of 97.5%.

For the substrate vaporized at 15 V, 1.540 mg of drug was applied to the substrate. After volatilization of drug from this substrate, 1.421 mg was recovered from the filter, for a percent yield of 92.3%. Purity of the drug aerosol particles was 98.6%. A total mass of 1.523 mg was recovered from the test apparatus and substrate, for a total recovery of 98.9%.

For the substrate vaporized at 17 V, 1.540 mg of drug was applied to the substrate. After volatilization of drug from this substrate, 1.424 mg was recovered from the filter, for a percent yield of 92.5%. Purity of the drug aerosol particles was 97.4%. A total mass of 1.467 mg was recovered from the test apparatus and substrate, for a total recovery of 95.3%.

FIG. 7 is a plot of the purity and yield data as a function of temperature for a 2.8 micron film thickness of prochlorperazine. Most points represent the average of several experiments at the same voltage.

### Example 3

Using a solution of 477 mg/mL prochlorperazine in acetone, stainless steel foils were coated (˜10.4 microns thick) and vaporized as described in Method B. The data were obtained and analyzed as described in Method C by varying the capacitor discharge voltage between 14 and 18 Volts, which results in peak substrate temperatures of 280 and 470 ° C., respectively.

For the substrate vaporized at 14 V, 5.737 mg of drug was applied to the substrate. After volatilization of drug from this substrate, 3.255 mg was recovered from the filter, for a percent yield of 56.7%. Purity of the drug aerosol particles was 97.8%. The total recovery from the test apparatus and substrate was approximately 100%.

For the substrate vaporized at 15 V, 5.737 mg of drug was applied to the substrate. After volatilization of drug from this substrate, 5.501 mg was recovered from the filter, for a percent yield of 95.9%. Purity of the drug aerosol particles was 97.4%. The total recovery from the test apparatus and substrate was approximately 100%.

For the substrate vaporized at 16 V, 5.737 mg of drug was applied to the substrate. After volatilization of drug from this substrate, 5.501 mg was recovered from the filter, for a percent yield of 95.9%. Purity of the drug aerosol particles was 96.7%. The total recovery from the test apparatus and substrate was approximately 100%.

For the substrate vaporized at 17 V, 5.737 mg of drug was applied to the substrate. After volatilization of drug from this substrate, 3.630 mg was recovered from the filter, for a percent yield of 63.3%. Purity of the drug aerosol particles was 95.7%. A total mass of 3.751 mg was recovered from the test apparatus and substrate, for a total recovery of 65.4%.

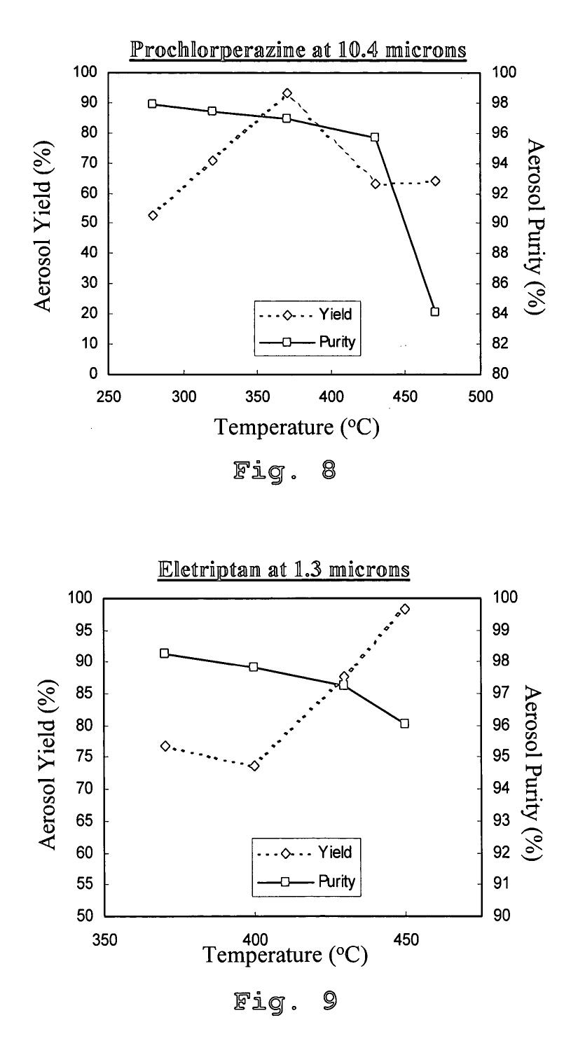

FIG. 8 is a plot of the purity and yield data as a function of temperature for a 10.4 micron film thickness of prochlorperazine. Most points represent the average of several experiments at the same voltage.

### Example 4

Using a solution of 100 mg/mL eletriptan in acetone, heat-treated stainless steel foils were coated (˜1.3 microns thick) and vaporized as described in Method B. The data were obtained and analyzed as described in Method C by varying the capacitor discharge voltage between 16 and 17.5 Volts, which results in peak substrate temperatures of 370 and 450 ° C., respectively

For the substrate vaporized at 16 V, 0.738 mg of drug was applied to the substrate. After volatilization of drug from this substrate, 0.584 mg was recovered from the filter, for a percent yield of 79.2%. Purity of the drug aerosol particles was 98.3%. A total mass of 0.628 mg was recovered from the test apparatus and substrate, for a total recovery of 85.1%.

For the substrate vaporized at 17.5 V, 0.751 mg of drug was applied to the substrate. After volatilization of drug from this substrate, 0.751 mg was recovered from the filter, for a percent yield of 100%. Purity of the drug aerosol particles was 96.1%. A total mass of 0.751 mg was recovered from the test apparatus and substrate, for a total recovery of 100%.

FIG. 9 is a plot of the purity and yield data as a function of temperature for a 1.3 micron film thickness of electriptan. Most points represent the average of several experiments at the same voltage.

### Example 5

Using a solution of 300 mg/mL eletriptan in acetone, heat-treated stainless steel foils were coated (˜1.3 microns thick) and vaporized as described in Method B. The data were obtained and analyzed as described in Method C by varying the capacitor discharge voltage between 16.5 and 17.5 Volts, which results in peak substrate temperatures of 400 and 450 ° C., respectively.

For the substrate vaporized at 16.5 V, 3.230 mg of drug was applied to the substrate. After volatilization of drug from this substrate, 1.526 mg was recovered from the filter, for a percent yield of 47.2%. Purity of the drug aerosol particles was 97.9%. A total mass of 2.784 mg was recovered from the test apparatus and substrate, for a total recovery of 86.2%.

For the substrate vaporized at 17.5 V, 3.230 mg of drug was applied to the substrate. After volatilization of drug from this substrate, 2.654 mg was recovered from the filter, for a percent yield of 82.2%. Purity of the drug aerosol particles was 94.5%. A total mass of 2.814 mg was recovered from the test apparatus and substrate, for a total recovery of 87.1%.

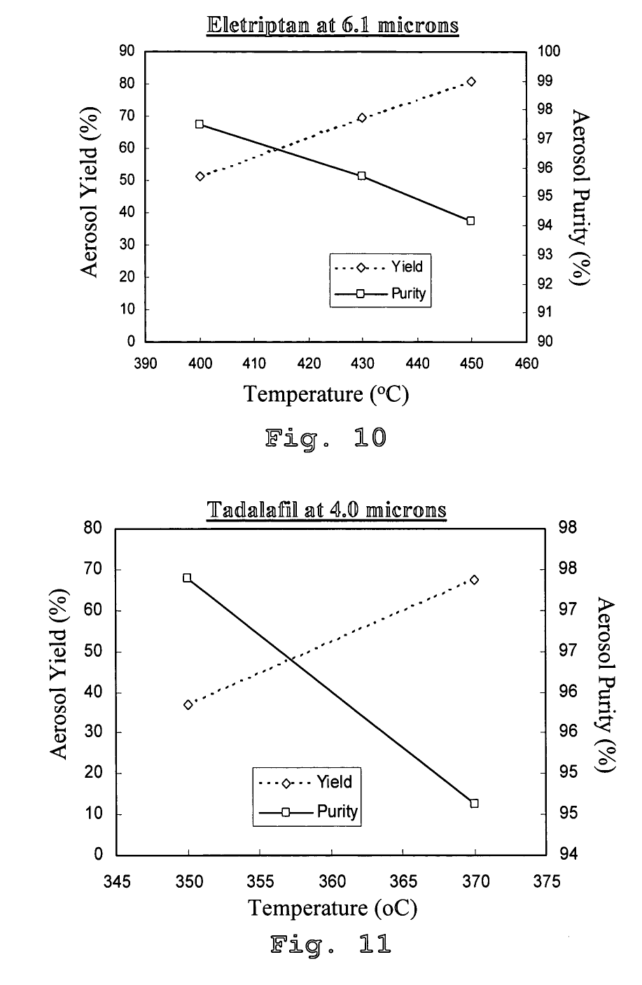

FIG. 10 is a plot of the purity and yield data as a function of temperature for a 6.1 micron film thickness of eletriptan. Most points represent the average of several experiments at the same voltage.

### Example 6

Using a solution of 330 mg/mL tadalafil in dimethylformamide, stainless steel foils were coated (˜4.0 microns thick) and vaporized as described in Method B. The data were obtained and analyzed as described in Method C by varying the capacitor discharge voltage between 15.5 and 16 Volts, which results in peak substrate temperatures of 350 and 370 ° C., respectively.

For the substrate vaporized at 15.5 V, 2.107 mg of drug was applied to the substrate. After volatilization of drug from this substrate, 0.809 mg was recovered from the filter, for a percent yield of 38.4%. Purity of the drug aerosol particles was 97.3%. A total mass of 1.627 mg was recovered from the test apparatus and substrate, for a total recovery of 77.2%.

For the substrate vaporized at 17.5 V, 2.107 mg of drug was applied to the substrate. After volatilization of drug from this substrate, 1.420 mg was recovered from the filter, for a percent yield of 67.4%. Purity of the drug aerosol particles was 95.8%. A total mass of 1.559 mg was recovered from the test apparatus and substrate, for a total recovery of 74.0%.

FIG. 11 is a plot of the purity and yield data as a function of temperature for a 4.0 micron film thickness of tadalafil. All points represent the average of two experiments at the same voltage.

### Example 7

Using a solution of 330 mg/mL tadalafil in dimethylformamide, stainless steel foils were coated (˜4.0 microns thick) and vaporized as described in Method B. The data was obtained and analyzed as described in Method D by varying the capacitor discharge voltage between 15.5 and 16 Volts, which results in peak substrate temperatures of 350 and 370° C., respectively.

Using a solution of 220 mg/mL tadalafil in dimethylformamide, stainless steel foils were coated (˜2.2 microns thick) and vaporized as described in Method B. The capacitor discharge voltage was varied between 15.5 and 16 Volts, which results in peak substrate temperatures of 350 and 370 ° C., respectively.

Using a solution of 110 mg/mL tadalafil in 1:1 dimethylformamide: chloroform, stainless steel foils were coated (˜1.3 microns thick) and vaporized as described in Method B. The capacitor discharge voltage was varied between 15.5 and 16 Volts, which results in peak substrate temperatures of 350 and 370 ° C., respectively.

Using a solution of 55 mg/mL tadalafil in dimethylformamide, stainless steel foils were coated (˜0.4 microns thick) and vaporized as described in Method B. The capacitor discharge voltage was varied between 15.5 and 16 Volts, which results in peak substrate temperatures of 350 and 370 ° C., respectively.

FIGS. 12A-12B are plots of the purity and/or yield data, shown in terms of 100% minus percent purity and 100% minus percent yield on the figures, as a function of the temperatures and film thicknesses tested. FIG. 12C is a plot showing the thickness and temperature window obtained for tadalafil where the aerosol has greater than 95% purity and a yield of greater than 90%.

### Example 8

Using a solution of 210 mg/mL valdecoxib in 3:1 chloroform/methanol, stainless steel foils were coated (˜8.0 microns thick) and vaporized as described in Method B. The data were obtained and analyzed as described in Method D by varying the capacitor discharge voltage between 15.5 and 16 Volts, which results in peak substrate temperatures of 350 and 370 ° C., respectively.

Using a solution of 105 mg/mL valdecoxib in 3:1 chloroform/methanol, stainless steel foils were coated (˜2.9 microns thick) and vaporized as described in Method B. The capacitor discharge voltage was varied between 15.5 and 16 Volts, which results in peak substrate temperatures of 350 and 370 ° C., respectively.

Using a solution of 55 mg/mL valdecoxib in 3:1 chloroform/methanol, stainless steel foils were coated (˜1.3 microns thick) and vaporized as described in Method B. The capacitor discharge voltage was varied between 15 and 16 Volts, which results in peak substrate temperatures of 320 and 370° C., respectively.

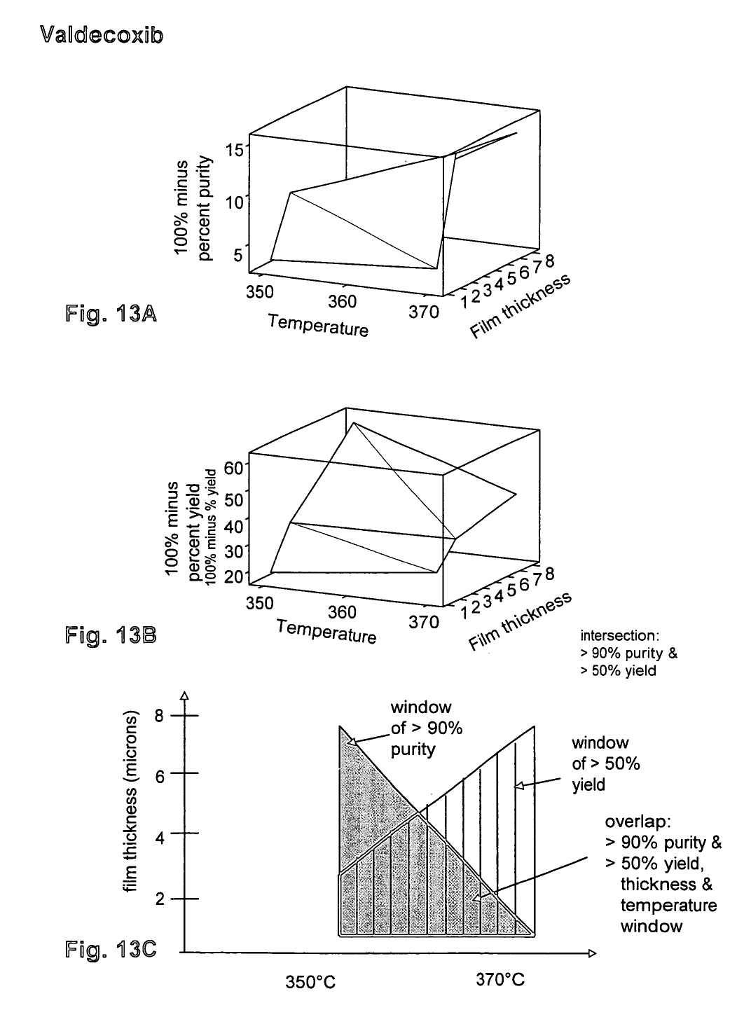

FIGS. 13A-13B are plots of the purity and/or yield data, shown in terms of 100% minus percent purity and 100% minus percent yield on the figures, as a function of the temperatures and film thicknesses tested. FIG. 13C is a plot showing the thickness and temperature window obtained for valdicoxib where the aerosol has greater than 90% purity and a yield of greater than 50%.

### Example 9

Using a solution of 90 mg/mL flunisolide in dichloromethane, heat-treated stainless steel foils were coated (˜1.2 microns thick) and vaporized as described in Method B. The data were obtained and analyzed as described in Method D by varying the capacitor discharge voltage between 14.5 and 16 Volts, which results in peak substrate temperatures of 300 and 370 ° C., respectively.

Using a solution of 60 mg/mL flunisolide in dichloromethane, heat-treated stainless steel foils were coated (˜0.9 microns thick) and vaporized as described in Method B. The capacitor discharge voltage was varied between 15 and 16 Volts, which results in peak substrate temperatures of 320 and 370 ° C., respectively.

Using a solution of 30 mg/mL flunisolide in dichloromethane, heat-treated stainless steel foils were coated (˜0.5 microns thick) and vaporized as described in Method B. The capacitor discharge voltage was varied between 15 and 16 Volts, which results in peak substrate temperatures of 320 and 370° C., respectively.

Using a solution of 150 mg/mL flunisolide in 9:1 dichloromethane:methanol, heat-treated stainless steel foils were coated (˜2.6 microns thick) and vaporized as described in Method B. The capacitor discharge voltage was varied between 15 and 16 Volts, which results in peak substrate temperatures of 320 and 370° C., respectively.

Using a solution of 15 mg/mL flunisolide in dichloromethane, heat-treated stainless steel foils were coated (˜0.2 microns thick) and vaporized as described in Method B. The capacitor discharge voltage was varied between 15 and 16 Volts, which results in peak substrate temperatures of 320 and 370° C., respectively.

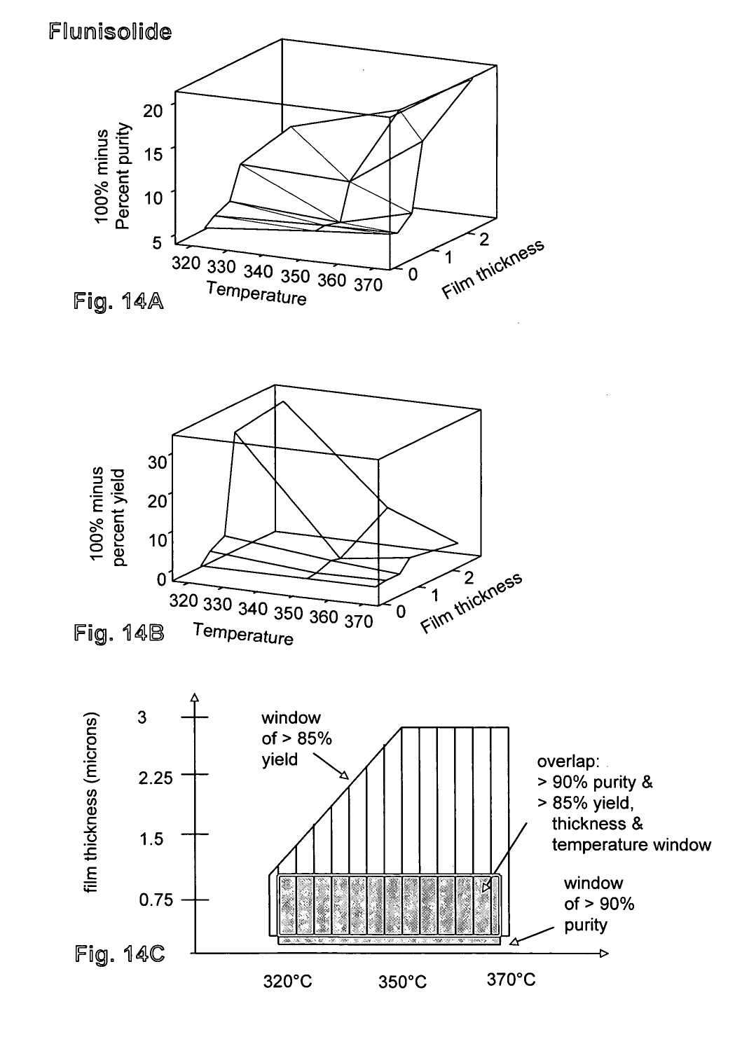

FIGS. 14A-14B are plots of the purity and/or yield data, shown in terms of 100% minus percent purity and 100% minus percent yield on the figures, as a function of the temperatures and film thicknesses tested. FIG. 14C is a plot showing the thickness and temperature window obtained for flunisolide where the aerosol has greater than 90% purity and a yield of greater than 85%.

### Example 10

Using a solution of 300 mg/mL eletriptan in acetone, heat-treated stainless steel foils were coated (˜6.1 microns thick) and vaporized as described in Method B. The data were obtained and analyzed as described in Method D by varying the capacitor discharge voltage between 16.5 and 17.5 Volts, which results in peak substrate temperatures of 400 and 450° C., respectively.

Using a solution of 200 mg/mL eletriptan in acetone, heat-treated stainless steel foils were coated (˜4.2 microns thick) and vaporized as described in Method B. The capacitor discharge voltage was varied between 16.5 and 17.5 Volts, which results in peak substrate temperatures of 400 and 450° C., respectively.

Using a solution of 380 mg/mL eletriptan in acetone, heat-treated stainless steel foils were coated (˜9.4 microns thick) and vaporized as described in Method B. The capacitor discharge voltage was varied between 17 and 17.5 Volts, which results in peak substrate temperatures of 430 and 450° C., respectively.

Using a solution of 100 mg/mL eletriptan in acetone, heat-treated stainless steel foils were coated (˜1.3 microns thick) and vaporized as described in Method B. The capacitor discharge voltage was varied between 16 and 17.5 Volts, which results in peak substrate temperatures of 370 and 450° C., respectively.

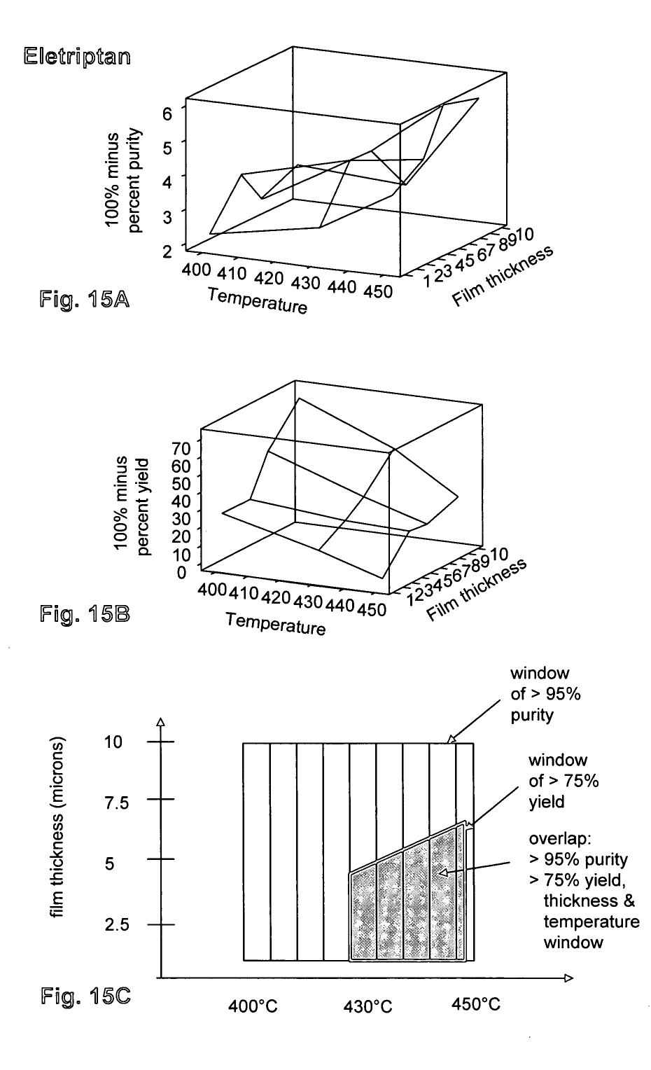

FIGS. 15A-15B are plots of the purity and/or yield data, shown in terms of 100% minus percent purity and 100% minus percent yield on the figures, as a function of the temperatures and film thicknesses tested. FIG. 15C is a plot showing the thickness and temperature window obtained for eletriptan where the aerosol has greater than 95% purity and a yield of greater than 75%.

### Example 11

Using a solution of 130 mg/mL albuterol in methanol, stainless steel foils were coated (˜1.6 microns thick) and vaporized as described in Method B. The data was obtained and analyzed as described in Method D by varying the capacitor discharge voltage between 14.5 and 15.5 Volts, which results in peak substrate temperatures of 300 and 350 ° C., respectively.

Using a solution of 65 mg/mL albuterol in methanol, stainless steel foils were coated (˜0.8 microns thick) and vaporized as described in Method B. The capacitor discharge voltage was varied between 14.5 and 15.5 Volts, which results in peak substrate temperatures of 300 and 350° C., respectively.

Using a solution of 40 mg/mL albuterol in methanol, stainless steel foils were coated (˜0.5 microns thick) and vaporized as described in Method B. The capacitor discharge voltage was varied between 14.5 and 15.5 Volts, which results in peak substrate temperatures of 300 and 350 ° C., respectively.

Using a solution of 20 mg/mL albuterol in methanol, stainless steel foils were coated (˜0.3 microns thick) and vaporized as described in Method B. The capacitor discharge voltage was varied between 14.5 and 15.5 Volts, which results in peak substrate temperatures of 300 and 350 ° C., respectively.

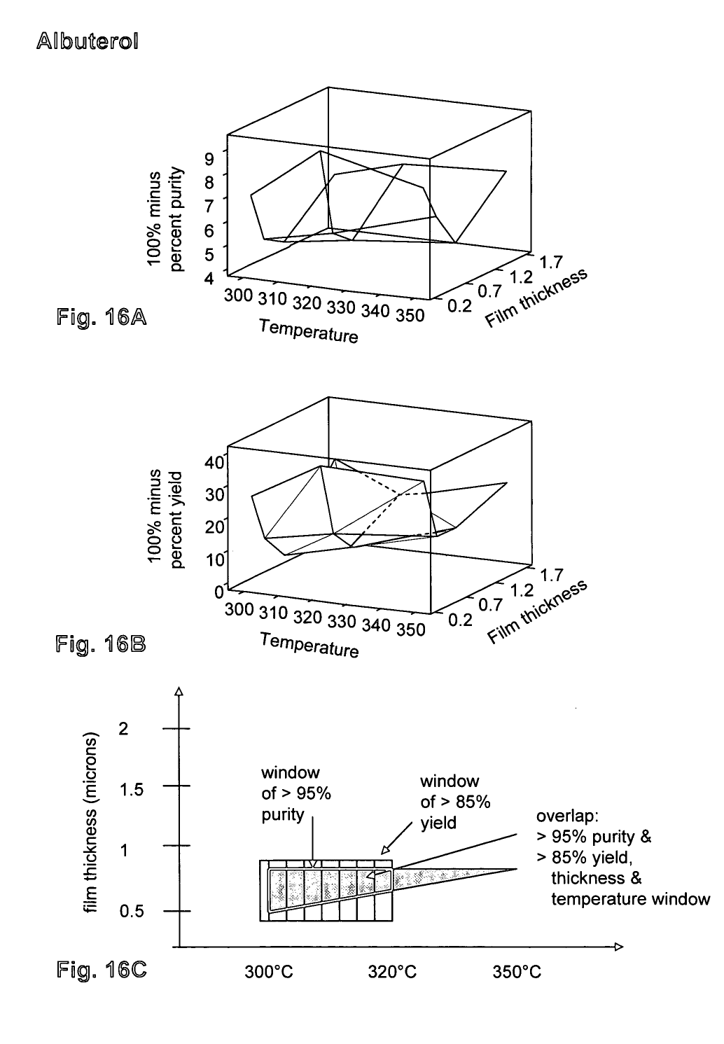

FIGS. 16A-16B are plots of the purity and/or yield data, shown in terms of 100% minus percent purity and 100% minus percent yield on the figures, as a function of the temperatures and film thicknesses tested. FIG. 16C is a plot showing the thickness and temperature window obtained for albuterol where the aerosol has greater than 95% purity and a yield of greater than 85%.

### Example 12

Using a solution of 125 mg/mL prochlorperazine in acetone, stainless steel foils were coated (˜2.8 microns thick) and vaporized as described in Method B. The data were obtained and analyzed as described in Method D by varying the capacitor discharge voltage between 13 and 17 Volts, which results in peak substrate temperatures of 240 and 430° C., respectively.

Using a solution of 477 mg/mL prochlorperazine in acetone, stainless steel foils were coated (˜10.4 microns thick) and vaporized as described in Method B. The capacitor discharge voltage was varied between 14 and 18 Volts, which results in peak substrate temperatures of 280 and 470° C., respectively.

Using a solution of 315 mg/mL prochlorperazine in acetone, stainless steel foils were coated (˜5.6 microns thick) and vaporized as described in Method B. The capacitor discharge voltage was varied between 14 and 18 Volts, which results in peak substrate temperatures of 280 and 470° C., respectively.

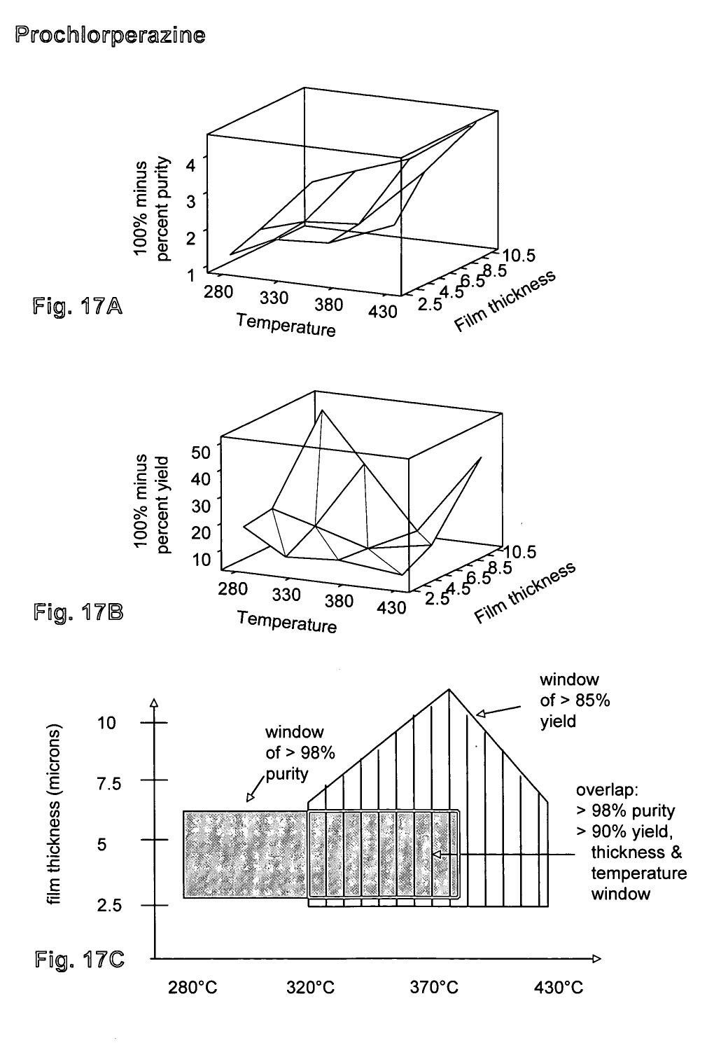

FIGS. 17A-17B are plots of the purity and/or yield data, shown in terms of 100% minus percent purity and 100% minus percent yield on the figures, as a function of the temperatures and film thicknesses tested. FIG. 17C is a plot showing the thickness and temperature window obtained for prochlorperazine where the aerosol has greater than 98% purity and a yield of greater than 85%.

### Example 13

Using a solution of 100 mg/mL sildenafil in 3:1 chloroform:methanol, stainless steel foils were coated (˜1.7 microns thick) and vaporized as described in Method B. The data were obtained and analyzed as described in Method D by varying the capacitor discharge voltage between 15.5 and 16 Volts, which results in peak substrate temperatures of 350 and 370° C., respectively.

Using a solution of 75 mg/mL sildenafil in 3:1 chloroform:methanol, stainless steel foils were coated (˜1.3 microns thick) and vaporized as described in Method B. The capacitor discharge voltage was varied between 15.5 and 16 Volts, which results in peak substrate temperatures of 350 and 370 ° C., respectively.

Using a solution of 50 mg/mL sildenafil in 3:1 chloroform:methanol, stainless steel foils were coated (˜0.8 microns thick) and vaporized as described in Method B. The capacitor discharge voltage was varied between 15.5 and 16 Volts, which results in peak substrate temperatures of 350 and 370 ° C., respectively.

Using a solution of 25 mg/mL sildenafil in 3:1 chloroform:methanol, stainless steel foils were coated (˜0.4 microns thick) and vaporized as described in Method B. The capacitor discharge voltage was varied between 15.5 and 16 Volts, which results in peak substrate temperatures of 350 and 370° C., respectively.

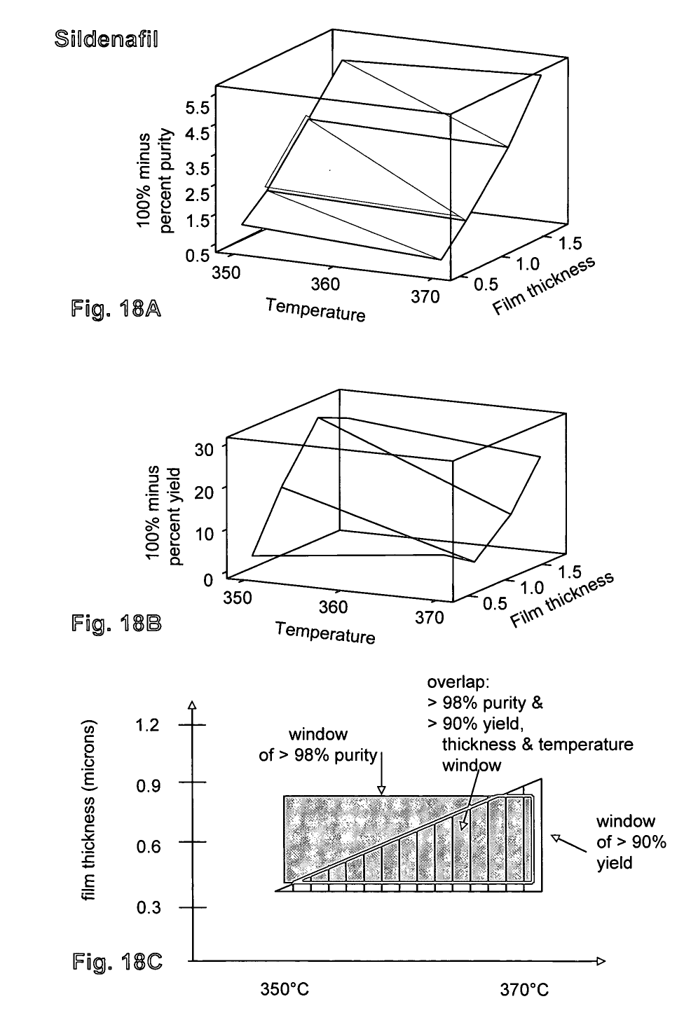

FIGS. 18A-18B are plots of the purity and/or yield data, shown in terms of 100% minus percent purity and 100% minus percent yield on the figures, as a function of the temperatures and film thicknesses tested. FIG. 18C is a plot showing the thickness and temperature window obtained for sildenafil where the aerosol has greater than 98% purity and a yield of greater than 90%.

### Example 14

Using a solution of 120 mg/mL fentanyl in acetonitrile, stainless steel foils were coated (˜1.4 microns thick) and vaporized as described in Method B. The data were obtained and analyzed as described in Method D by varying the capacitor discharge voltage between 13.5 and 15 Volts, which results in peak substrate temperatures of 260 and 320 ° C., respectively.

Using a solution of 60 mg/mL fentanyl in acetonitrile, stainless steel foils were coated (˜0.8 microns thick) and vaporized as described in Method B. The capacitor discharge voltage was varied between 13.5 and 15 Volts, which results in peak substrate temperatures of 260 and 320 ° C., respectively.

Using a solution of 40 mg/mL fentanyl in acetonitrile, stainless steel foils were coated (˜0.5 microns thick) and vaporized as described in Method B. The capacitor discharge voltage was varied between 13.5 and 15 Volts, which results in peak substrate temperatures of 260 and 320 ° C., respectively.

Using a solution of 25 mg/mL fentanyl in acetonitrile, stainless steel foils were coated (˜0.3 microns thick) and vaporized as described in Method B. The capacitor discharge voltage was varied between 13.5 and 15 Volts, which results in peak substrate temperatures of 260 and 320 ° C., respectively.

Using a solution of 200 mg/mL fentanyl in acetonitrile, stainless steel foils were coated (˜3.2 microns thick) and vaporized as described in Method B. The capacitor discharge voltage was varied between 13.5 and 15 Volts, which results in peak substrate temperatures of 260 and 320° C., respectively.

Using a solution of 40 mg/mL fentanyl in acetonitrile, stainless steel foils were coated (˜0.4 microns thick) and vaporized as described in Method B. The capacitor discharge voltage was varied between 13.5 and 15 Volts, which results in peak substrate temperatures of 260 and 320° C., respectively.

FIGS. 19A-19B are plots of the purity and/or yield data, shown in terms of 100% minus percent purity and 100% minus percent yield on the figures, as a function of the temperatures and film thicknesses tested. FIG. 19C is a plot showing the thickness and temperature window obtained for fentanyl where the aerosol has greater than 95% purity and a yield of greater than 75%.

The foregoing examples illustrate various aspects of the invention and practice of the methods of the invention. The examples are not intended to provide an exhaustive description of the many different embodiments of the invention. Thus, although the foregoing invention has been described in some detail by way of illustration and example for purposes of clarity and understanding, those of ordinary skill in the art will realize readily that many changes and modifications can be made thereto without departing from the spirit or scope of the appended claims.

1. A method for determining a film thickness of a drug composition to be aerosolized from a film on a substrate, for use in forming an aerosol delivery article, comprising:
(a) acquiring yields and purities of the drug composition in an aerosol formed by vaporizing the film from the substrate as a function of film thickness and temperature, at two or more selected temperatures within a temperature range of about 150° C. to 550° C. and two or more selected film thicknesses within a thickness range of about 0.05 and 50 microns,
(b) determining from said yields and purities if a thickness and temperature exist where the aerosol has at least 90% purity and at least 50% yield; and
(c) repeating step (a), if necessary, for each of one or more different selected film thicknesses in the thickness range of about 0.05 to 50 microns, or one or more different selected temperatures in the temperature range of about 150° C. to 550° C., respectively, until the purity and yield in (b) are met.

2. The method of claim 1, wherein step (a) includes (i) depositing on a substrate a film of the drug composition having a selected thickness in the thickness range of about 0.05-50 microns, (ii) heating the substrate to a selected temperature in the temperature range of about 150° C.-550° C., to vaporize the film, (iii) collecting the aerosol formed from the vaporized drug composition, (iv) determining the percent yield and percent purity of drug composition in the collected aerosol, and (v) repeating steps (i)-(iv) for one or more different selected temperatures in the temperature range of about 150° C. to 550° C. and one or more different selected film thicknesses in the thickness range of about 0.05 and 50 microns.

3. The method of claim 1, wherein the aerosol has a purity of at least 95%.

4. The method of claim 3, wherein the aerosol has a purity of at least 98%.

5. The method of claim 3, wherein the aerosol has a yield of at least 75%.

6. The method of claim 5, wherein the aerosol has a yield of at least 85%

7. The method of claim 6, wherein the aerosol has a yield of at least 90%.

8. The method of claim 1, wherein the generating yields and purities as a function of film thickness and temperature, at two or more selected temperatures within a temperature range of about 150° C. to 550° C. in step (a) covers a degree range of at least 30 degrees ° C.

9. The method of claim 8, wherein the degree range is at least 50 degrees ° C.

10. The method of claim 8, wherein the degree range is at least 90 degrees ° C.

11. The method of claim 1, wherein the generating yields and purities as a function of film thickness and temperature, at two or more selected film thickness within a thickness range of about 0.05 and 50 microns in step (a) covers a micron range of at least 1 micron.

12. The method of claim 11, wherein the micron range is at least 2 microns.

13. The method of claim 11, wherein the micron range is at least 5 microns.

14. The method of claim 1, wherein said determining in step (b) further comprises determining if a thickness window of at least 1 micron exists over which the aerosol has at least 90% purity and at least 50% yield.

15. The method of claim 1, wherein said determining in step (b) further comprises determining if a temperature window of at least 40 degrees ° C. exists over which the aerosol has at least 90% purity and at least 50% yield.

16. The method of claim 1, wherein said determining in step (b) further comprises determining if a temperature window of at least 80 degrees ° C. exists over which the aerosol has at least 90% purity and at least 50% yield.

17. The method of claim 1, wherein step (c) includes selecting a film thickness less than the selected film thicknesses used to acquire the yields and purities in step (a), when the purity of the aerosol in step (b) is determined to be less than 90%.

18. The method of claim 1 wherein step (c) includes selecting a temperature greater than the selected temperatures used in step (a), when the yield of the aerosol in step (b) is determined to be less than 50%.

19. The method of claim 1, wherein said determining in step (b) further comprises determining if a thickness and temperature window exists where the aerosol has purities of 90% or greater and yields of 50% or greater.

20. The method of claim 19, wherein the determining if a thickness and temperature window exists, includes (i) determining from said yields and said purities if a purity window exists as a function of temperature and thickness, where the aerosol has at least 90% purity, (ii) determining from said yields and said purities if a yield window exists as a function of temperature and thickness, where the aerosol has at least 50% yield; and (iii) determining if there is any overlap of the purity window and yield window in steps (i) and (ii).

21. The method of claim 1, which further includes selecting a substrate surface area which for a selected film thickness yields an effective human therapeutic dose of the compound.

22. The method of claim 21, wherein said substrate surface area is between about 0.05-100 cm².

23. The method of claim 1, wherein the substrate surface is impermeable.

24. The method of claim 1, wherein said substrate has a contiguous surface area of greater than 1 mm² and a material density of greater than 0.5 g/cc.

25. The method of claim 1, wherein said drug composition is characterized by increasing levels of drug degradation products in said aerosol, with increasing film thicknesses above a selected film thickness in the range 0.05 to 20 microns.

26. The method of claim 1, wherein said drug composition is selected from the group consisting of the following, where for each drug composition, there is shown a range of film thickness within which the corresponding drug composition film thickness is selected:
(1) alprazolam, film thickness between 0.1 and 10 μm;
(2) amoxapine, film thickness between 2 and 20 μm;
(3) atropine, film thickness between 0.1 and 10 μm;
(4) bumetanide film thickness between 0.1 and 5 μm;
(5) buprenorphine, film thickness between 0.05 and 10 μm;
(6) butorphanol, film thickness between 0.1 and 10 μm;
(7) clomipramine, film thickness between 1 and 8 μm;
(8) donepezil, film thickness between 1 and 10 μm;
(9) hydromorphone, film thickness between 0.05 and 10 μm;
(10) loxapine, film thickness between 1 and 20 μm;
(11) midazolam, film thickness between 0.05 and 20 μm;
(12) morphine, film thickness between 0.2 and 10 μm;
(13) nalbuphine, film thickness between 0.2 and 5 μm;
(14) naratriptan, film thickness between 0.2 and 5 μm;
(15) olanzapine, film thickness between 1 and 20 μm;
(16) paroxetine, film thickness between 1 and 20 μm;
(17) prochlorperazine, film thickness between 0.1 and 20 μm;
(18) quetiapine, film thickness between 1 and 20 μm;
(19) sertraline, film thickness between 1 and 20 μm;
(20) sibutramine, film thickness between 0.5 and 2 μm;
(21) sildenafil, film thickness between 0.2 and 3 μm;
(22) sumatriptan, film thickness between 0.2 and 6 μm;
(23) tadalafil, film thickness between 0.2 and 5 μm;
(24) vardenafil, film thickness between 0.1 and 2 μm;
(25) venlafaxine, film thickness between 2 and 20 μm;
(26) zolpidem, film thickness between 0.1 and 10 μm;
(27) apomorphine HCl, film thickness between 0.1 and 5 μm;
(28) celecoxib, film thickness between 2 and 20 μm;
(29) ciclesonide, film thickness between 0.05 and 5 μm;
(30) eletriptan, film thickness between 0.2 and 20 μm;
(31) parecoxib, film thickness between 0.5 and 2 μm;
(32) valdecoxib, film thickness between 0.5 and 10 μm; and
(33) fentanyl, film thickness between 0.05 and 5 μm.

27. A method for determining a film thickness of a drug composition to be aerosolized from a film on a substrate and a defined heating temperature of the substrate to provide a selected minimum yield and selected minimum purity of aerosol from the film, for use in forming an aerosol delivery article, comprising:
(a) generating purity(es) of the drug composition in an aerosol formed by vaporizing the film from a substrate at one or more selected film thicknesses within a thickness range of about 0.05 and 50 microns at a selected temperature in the temperature range of about 150° C. to 550° C.,
(b) determining from said purity(es) if a defined thickness exists where the aerosol has a selected minimum purity,
(c) repeating steps (a) and (b), if necessary, for each of one or more different selected film thicknesses in the thickness range of about 0.05 to 50 microns until a defined thickness exists where the aerosol has the selected minimum purity,
(d) generating yields and purities of the drug composition in an aerosol formed by vaporizing the film of a selected thickness of the drug composition from a substrate at two or more different selected temperatures in the temperature range of about 150° C. to 550° C., or, at the same selected temperature in step (a) and one or more different selected temperatures in the temperature range of about 150° C. to 550° C.,
(e) determining from said yields and purities if a defined temperature exists where the aerosol formed has a selected minimum yield, and
(f) repeating steps (d) and (e), if necessary, for each of one or more different temperatures in the temperature range of about 150° C. to 550° C. until a defined temperature exists where the aerosol has the selected minimum yield.

28. The method of claim 27, further comprising determining a temperature window over which the yields obtained are equal to or greater than the selected minimum yield for the selected minimum purity.

29. The method of claim 28, wherein said determining further comprises plotting the yields and purities at the defined thickness as a function of temperature.

30. The method of claim 27, wherein the selected minimum purity is at least 90%.

31. The method of claim 30, wherein the selected minimum purity is at least 95%.

32. The method of claim 31, wherein the selected minimum purity is at least 98%.

33. The method of claim 30, wherein the selected minimum yield is at least 50%.

34. The method of claim 33, wherein the selected minimum yield is at least 75%.

35. The method of claim 34, wherein the selected minimum yield is at least 85%.

36. The method of claim 35, wherein the selected minimum yield is at least 90%.

37. The method of claim 27, which further includes selecting a substrate surface area which for a selected film thickness yields an effective human therapeutic dose of the compound.

38. The method of claim 37, wherein said substrate surface area is between about 0.05-100 cm.

39. The method of claim 27, wherein the substrate surface is impermeable.

40. The method of claim 27, wherein said substrate has a contiguous surface area of greater than 1 mm² and a material density of greater than 0.5 g/cc.

41. The method of claim 27, wherein said drug composition is characterized by increasing levels of drug degradation products in said aerosol, with increasing film thicknesses above a selected film thickness in the range 0.05 to 20 microns.

42. The method of claim 27, wherein said drug composition is selected from the group consisting of the following, where for each drug composition, there is shown a range of film thickness within which the corresponding drug composition film thickness is selected:
(1) alprazolam, film thickness between 0.1 and 10 μm;
(2) amoxapine, film thickness between 2 and 20 μm;
(3) atropine, film thickness between 0.1 and 10 μm;
(4) bumetanide film thickness between 0.1 and 5 μm;
(5) buprenorphine, film thickness between 0.05 and 10 μm;
(6) butorphanol, film thickness between 0.1 and 10 μm;
(7) clomipramine, film thickness between 1 and 8 μm;
(8) donepezil, film thickness between 1 and 10 μm;
(9) hydromorphone, film thickness between 0.05 and 10 μm;
(10) loxapine, film thickness between 1 and 20 μm;
(11) midazolam, film thickness between 0.05 and 20 μm;
(12) morphine, film thickness between 0.2 and 10 μm;
(13) nalbuphine, film thickness between 0.2 and 5 μm;
(14) naratriptan, film thickness between 0.2 and 5 μm;
(15) olanzapine, film thickness between 1 and 20 μm;
(16) paroxetine, film thickness between 1 and 20 μm;
(17) prochlorperazine, film thickness between 0.1 and 20 μm;
(18) quetiapine, film thickness between 1 and 20 μm;
(19) sertraline, film thickness between 1 and 20 μm;
(20) sibutramine, film thickness between 0.5 and 2 μm;
(21) sildenafil, film thickness between 0.2 and 3 μm;
(22) sumatriptan, film thickness between 0.2 and 6 μm;
(23) tadalafil, film thickness between 0.2 and 5 μm;
(24) vardenafil, film thickness between 0.1 and 2 μm;
(25) venlafaxine, film thickness between 2 and 20 μm;
(26) zolpidem, film thickness between 0.1 and 10 μm;
(27) apomorphine HCl, film thickness between 0.1 and 5 μm;
(28) celecoxib, film thickness between 2 and 20 μm;
(29) ciclesonide, film thickness between 0.05 and 5 μm;
(30) eletriptan, film thickness between 0.2 and 20 μm;
(31) parecoxib, film thickness between 0.5 and 2 μm;
(32) valdecoxib, film thickness between 0.5 and 10 μm; and
(33) fentanyl, film thickness between 0.05 and 5 μm.
